(19) United States
(12) Patent Application Publication
(10) Pub. No.: US 2025/0106625 A1
(43) Pub. Date: Mar. 27, 2025

(54) ESTABLISHMENT OF NETWORK CONNECTION FOR A COMMUNICATION DEVICE

(71) Applicant: TELEFONAKTIEBOLAGET LM ERICSSON (PUBL), STOCKHOLM (SE)

(72) Inventors: Per Ståhl, KLAGSHAMN (SE); Juha Sääskilahti, ESPOO (FI); Qiang Li, TÄBY (SE)

(21) Appl. No.: 18/728,691

(22) PCT Filed: Jan. 12, 2022
(86) PCT No.: PCT/EP2022/050484

§ 371 Date: Jul. 12, 2024

(51) Int. Cl. H04W 12/043; H04W 12/06; H04W 12/106

(52) U.S. Cl. CPC H04W 12/043; H04W 12/06; H04W 12/106

(57) ABSTRACT

There is provided mechanisms where a 5G SUCI and EAP framework is leveraged to tunnel the consumer eSIM common mutual authentication, eSIM credentials provided in a communication device can be leveraged during network access authentication such that network connectivity can be obtained for the communication device. This is achieved without making any changes to existing SM and eUICC interfaces. The embodiments also allow continued profde download, leveraging an already established session with the SM. This enables further common mutual authentication to be avoided.

### TECHNICAL FIELD

Embodiments presented herein relate to a method, a communication device, a computer program, and a computer program product for establishing network connection for a communication device. Embodiments presented herein further relate to a method, an eSIM server, a computer program, and a computer program product for assisting in establishing network connection for a communication device.

### BACKGROUND

The GSM Association (GSMA; where GSM is short for Global System for Mobile Communications) has specified techniques to provide subscribers with 3rd Generation Partnership Project (3GPP) subscription profiles, so called Subscriber Identity Module (SIM) profiles, which can be remotely downloaded over the Internet to physical hardware in a cellular communication device, known as embedded universal integrated circuit card (eUICC), replacing current physical SIM cards. The technique is referred to as eSIM. Two variants of are specified; one for Internet-of-Things (IoT) and machine-to-machine (M2M) communication devices (GSMA SGP.02 Remote Provisioning Architecture for Embedded UICC, Technical Specification. Version 4.2) and one for consumer communication devices (GSMA SGP.22 RSP Technical Specification. Version 2.4). The latter is also currently being considered for use with IoT communication devices due to the complexity of the M2M eSIM variant. In order for the communication device to remotely download a new subscription, it needs connectivity to communicate with a remote provisioning server. This connectivity may either be cellular connectivity or non-cellular connectivity using an additional radio. For low-cost constrained IoT communication devices, the introduction of an additional radio, which may be used only once to download a first profile, adds both extra hardware and complexity to the communication device, in addition to adding cost. The use of cellular connectivity currently implies that a SIM profile must already be present in the communication device. In particular, to gain initial connectivity when the communication device starts up for the first time, a suitable SIM profile that is usable where the communication device is geographically located needs to be installed into the communication device at manufacturing. Such a profile is commonly referred to as a bootstrap profile or a provisioning profile. It is often not known at which geographical location a particular communication device will be deployed when the eUICC or the communication device is manufactured. For this reason, a provisioning profile of a mobile network operator (MNO) with global roaming agreements is needed.

One way to address this issue is to use a special bootstrap profile that allows a suitable international mobile subscriber identity (IMSI) and associated credentials to be selected and used during the download of the operational profile. However, this might require changes to the eUICC and/or the provisioning server.

The network access authentication in some communication networks leverages the Extensible Authentication Protocol (EAP) framework that allows different EAP-based authentication methods to be used. Currently, for public (cellular) networks the EAP Authentication and Key Agreement prime (EAP-AKA′) method is the only allowed method for the so-called primary authentication required to get initial connectivity, but for non-public (cellular) networks also other EAP methods can be used, such as EAP Transport Layer Security (EAP-TLS). EAP-TLS and other EAP methods that leverages Subscription Manager Data Preparation plus (SM-DP+) credentials and eUICC credentials on an eUICC supporting the eSIM consumer variant requires changes to the provisioning server and/or the eUICC and prevents the use of standard provisioning servers and eUICCs.

### SUMMARY

An object of embodiments herein is to address the above issues.

In some aspects, the above issues are addressed by embodiments where a fifth generation telecommunication network (5G) Subscription Concealed Identifier (SUCI) and EAP framework is leveraged to tunnel the consumer eSIM common mutual authentication between the subscription manager and the eUICC, eSIM credentials provided in a communication device can be leveraged during network access authentication such that network connectivity can be obtained for the communication device. This is achieved without making any changes to existing subscription manager and eUICC interfaces. The embodiments also allow continued profile download, leveraging an already established session with the subscription manager. This enables further common mutual authentication to be avoided.

According to a first aspect there is presented a method for establishing network connectivity for a communication device. The method is performed by the communication device. The communication device comprises an identity module supporting remote subscription profile download. The method comprises providing a SUCI, encrypted data comprising a device challenge, a public key of an ephemeral key pair of the communication device, and an identity module challenge towards an eSIM server. The encrypted data is based on an eSIM server public key and the ephemeral key pair of the communication device. The method comprises obtaining a public key of an ephemeral key pair of the eSIM server, a subscription manager (SM) challenge, an SM signature, and authentication data from the eSIM server in an EAP request. The SM challenge and the SM signature are extracted from the authentication data. The SM signature has been computed on data comprises the identity module challenge. The method comprises verifying the authentication data to obtain proof of the eSIM server knowledge of the device challenge. The verification of the received authentication data is performed using the public key of the ephemeral key pair of the eSIM server and the device challenge. The SM signature is verified using the identity module and the identity module challenge as locally stored, and where an identity module signature computed on data comprises the received SM challenge is returned from the identity module upon successful verification. The method comprises providing an EAP response towards the eSIM server. The EAP response comprises the identity module signature. The method comprises establishing network connectivity upon having obtained an EAP success message indicating successful authentication of the communication device.

According to a second aspect there is presented a communication device for establishing network connection for the communication device. The communication device comprises an identity module supporting remote subscription profile download. The communication device comprises processing circuitry. The processing circuitry is configured to cause the communication device to provide a SUCI, encrypted data comprising a device challenge, a public key of an ephemeral key pair of the communication device, and an identity module challenge towards an eSIM server. The encrypted data is based on an eSIM server public key and the ephemeral key pair of the communication device. The processing circuitry is configured to cause the communication device to obtain a public key of an ephemeral key pair of the eSIM server, an SM challenge, an SM signature, and authentication data from the eSIM server in an EAP request. The SM challenge and the SM signature are extracted from the authentication data. The SM signature has been computed on data comprises the identity module challenge. The processing circuitry is configured to cause the communication device to verify the authentication data to obtain proof of the eSIM server knowledge of the device challenge. The verification of the received authentication data is performed using the public key of the ephemeral key pair of the eSIM server and the device challenge. The SM signature is verified using the identity module and the identity module challenge as locally stored, and where an identity module signature computed on data comprises the received SM challenge is returned from the identity module upon successful verification. The processing circuitry is configured to cause the communication device to provide an EAP response towards the eSIM server. The EAP response comprises the identity module signature. The processing circuitry is configured to cause the communication device to establish network connectivity upon having obtained an EAP success message indicating successful authentication of the communication device.

According to a third aspect there is presented a communication device for establishing network connection for the communication device. The communication device comprises an identity module supporting remote subscription profile download. The communication device comprises a provide module configured to provide a SUCI, encrypted data comprising a device challenge, a public key of an ephemeral key pair of the communication device, and an identity module challenge towards an eSIM server. The encrypted data is based on an eSIM server public key and the ephemeral key pair of the communication device. The communication device comprises an obtain module configured to obtain a public key of an ephemeral key pair of the eSIM server, an SM challenge, an SM signature, and authentication data from the eSIM server in an EAP request. The SM challenge and the SM signature are extracted from the authentication data. The SM signature has been computed on data comprises the identity module challenge. The communication device comprises a verify module configured to verify the authentication data to obtain proof of the eSIM server knowledge of the device challenge. The verification of the received authentication data is performed using the public key of the ephemeral key pair of the eSIM server and the device challenge. The SM signature is verified using the identity module and the identity module challenge as locally stored, and where an identity module signature computed on data comprises the received SM challenge is returned from the identity module upon successful verification. The communication device comprises a provide module configured to provide an EAP response towards the eSIM server. The EAP response comprises the identity module signature. The communication device comprises an establish module configured to establish network connectivity upon having obtained an EAP success message indicating successful authentication of the communication device.

According to a fourth aspect there is presented a computer program for establishing network connection for a communication device, the computer program comprising computer program code which, when run on processing circuitry of a communication device, causes the communication device to perform a method according to the first aspect.

According to a fifth aspect there is presented a method for assisting in establishing network connectivity for a communication device. The method is performed by an eSIM server. The method comprises obtaining a SUCI, encrypted data comprising a device challenge, a public key of an ephemeral key pair of the communication device, and an identity module challenge from the communication device, wherein the encrypted data is based on an eSIM server public key and the ephemeral key pair of the communication device. The method comprises providing the identity module challenge to a provisioning server over a secure communication channel established between the eSIM server and the provisioning server, and receiving an SM challenge and an SM signature computed by the provisioning server on data comprises the identity module challenge in return from the provisioning server. The method comprises generating authentication data using an ephemeral key pair of the eSIM server. The authentication data provides proof of the eSIM server knowledge of the device challenge. The authentication data comprises the SM challenge and the SM signature. The method comprises providing an EAP request towards the communication device. The EAP request comprises a public key of the ephemeral key pair of the eSIM server and the authentication data. The method comprises obtaining an EAP response from the communication device in an authentication request. The EAP response comprises an identity module signature. The method comprises obtaining an indication of successful authentication of the communication device. Successful authentication of the communication device comprises successful verification of the identity module signature. The method comprises providing, upon having obtained the indication of successful authentication of the communication device, a response to the authentication request towards the communication device comprises an EAP success message indicating successful authentication of the communication device for network connectivity to be established with the communication device.

According to a sixth aspect there is presented an eSIM server for assisting in establishing network connection for a communication device. The eSIM server comprises processing circuitry. The processing circuitry is configured to cause the eSIM server to obtain a SUCI, encrypted data comprising a device challenge, a public key of an ephemeral key pair of the communication device, and an identity module challenge from the communication device, wherein the encrypted data is based on an eSIM server public key and the ephemeral key pair of the communication device. The processing circuitry is configured to cause the eSIM server to provide the identity module challenge to a provisioning server over a secure communication channel established between the eSIM server and the provisioning server, and to receive an SM challenge and an SM signature computed by the provisioning server on data comprises the identity module challenge in return from the provisioning server. The processing circuitry is configured to cause the eSIM server to generate authentication data using an ephemeral key pair of the eSIM server. The authentication data provides proof of the eSIM server knowledge of the device challenge. The authentication data comprises the SM challenge and the SM signature. The processing circuitry is configured to cause the eSIM server to provide an EAP request towards the communication device. The EAP request comprises a public key of the ephemeral key pair of the eSIM server and the authentication data. The processing circuitry is configured to cause the eSIM server to obtain an EAP response from the communication device in an authentication request. The EAP response comprises an identity module signature. The processing circuitry is configured to cause the eSIM server to obtain an indication of successful authentication of the communication device. Successful authentication of the communication device comprises successful verification of the identity module signature. The processing circuitry is configured to cause the eSIM server to provide, upon having obtained the indication of successful authentication of the communication device, a response to the authentication request towards the communication device comprises an EAP success message indicating successful authentication of the communication device for network connectivity to be established with the communication device.

According to a seventh aspect there is presented an eSIM server for assisting in establishing network connection for a communication device. The eSIM server comprises an obtain module configured to obtain a SUCI, encrypted data comprising a device challenge, a public key of an ephemeral key pair of the communication device, and an identity module challenge from the communication device, wherein the encrypted data is based on an eSIM server public key and the ephemeral key pair of the communication device. The eSIM server comprises a provide module configured to provide the identity module challenge to a provisioning server over a secure communication channel established between the eSIM server and the SM, and receiving an SM challenge and an SM signature computed by the provisioning server on data comprises the identity module challenge in return from the provisioning server. The eSIM server comprises a generate module configured to generate authentication data using an ephemeral key pair of the eSIM server. The authentication data provides proof of the eSIM server knowledge of the device challenge. The authentication data comprises the SM challenge and the SM signature. The eSIM server comprises a provide module configured to provide an EAP request towards the communication device. The EAP request comprises a public key of the ephemeral key pair of the eSIM server and the authentication data. The eSIM server comprises an obtain module configured to obtain an EAP response from the communication device in an authentication request. The EAP response comprises an identity module signature. The eSIM server comprises an obtain module configured to obtain an indication of successful authentication of the communication device. Successful authentication of the communication device comprises successful verification of the identity module signature. The eSIM server comprises a provide module configured to provide, upon having obtained the indication of successful authentication of the communication device, a response to the authentication request towards the communication device comprises an EAP success message indicating successful authentication of the communication device for network connectivity to be established with the communication device.

According to an eighth aspect there is presented a computer program for assisting in establishing network connection for a communication device, the computer program comprising computer program code which, when run on processing circuitry of an eSIM server, causes the eSIM server to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects enable network connection to be established for a communication device being without an operational profile in an efficient manner.

Advantageously, these aspects do not require each communication device to have a regular subscription profile with an IMSI to connect to an initial 3GPP network. In turn, this reduces the number of regular subscription profiles with an IMSI that need to be used.

Advantageously, these aspects enable an eSIM server to be set up for communication devices that can gain initial connectivity to public or non-public networks by performing network access authentication where eSIM credentials are leveraged. This can be achieved without requiring any changes in the provisioning sever or the eUICC.

Advantageously, the eSIM server can be combined with an eSIM provisioning service in an efficient way by re-using the common mutual authentication procedure between the provisioning server and the eUICC both for network access authentication and profile download. In turn, this saves the number of bits needed to be sent by the communication device. In turn, this can reduce the energy requirements of the communication device, thus prolonging the lifetime of the communication device.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to an embodiment;

FIG. 2 schematically illustrates signalling between entities in the communication network of FIG. 1 according to an embodiment;

FIGS. 3 and 4 are flowcharts of methods according to embodiments;

FIGS. 5-9 are signalling diagrams of methods according to embodiments;

FIG. 10 is a schematic diagram showing functional units of a communication device according to an embodiment;

FIG. 11 is a schematic diagram showing functional modules of a communication device according to an embodiment;

FIG. 12 is a schematic diagram showing functional units of an eSIM server according to an embodiment;

FIG. 13 is a schematic diagram showing functional modules of an eSIM server according to an embodiment; and

FIG. 14 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

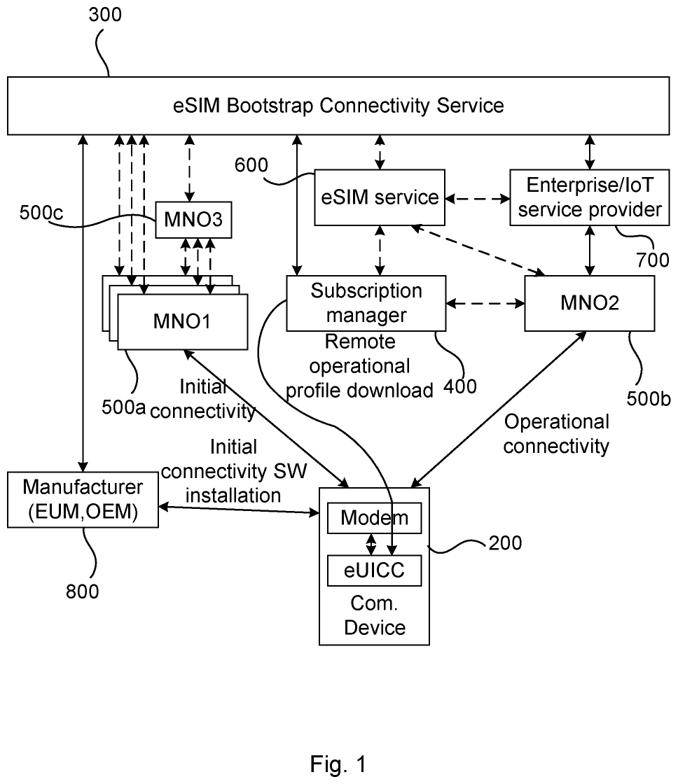

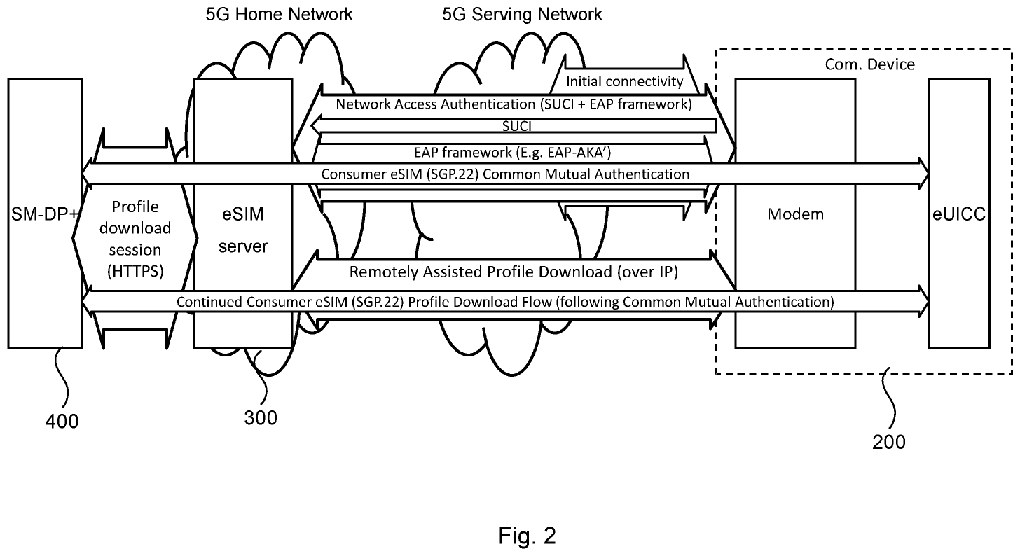

FIG. 1 is a block diagram illustrating a communication network where embodiments presented herein can be applied. FIG. 2 schematically illustrates signalling for network access authentication for initial connectivity and remotely assisted profile download between the entities of the communication network in FIG. 1. FIG. 1 and FIG. 2 will now be described in parallel. In the block diagram in FIG. 1, dashed lines indicate connections that may be optional depending on the eSIM service and eSIM server.

A communication device 200 comprises an identity module, such as an eUICC, supporting remote SIM provisioning, for example according to the GSMA eSIM consumer variant. The identity module comprises credentials (such as eUICC credentials) for secure profile download from a subscription manager 400. The credentials comprise an elliptic curve (EC) private key and an eUICC certificate comprising the corresponding public key. The eUICC certificate also comprises the identity module identifier, such as an eUICC identifier (EID).

The communication device 200 comprises a cellular modem, or just modem for short. Commonly, the communication device 200 connects to a public mobile network, and/or a private network, based on an active operational SIM profile. The modem is configured to check if such an active profile is present. If a profile is not present, e.g. for the first start-up of the communication device 200, the modem performs the network access authentication for (initial) connectivity with the help of the identity module and the eSIM consumer common mutual authentication procedure. Connectivity is established using a first mobile network (MNO1) 500a. Using the eSIM remote SIM download mechanism the identity module may then be provisioned with an operational SIM profile from the second mobile network MNO2 500b. MNO1 and MNO2 may be one and the same network. After this profile has been activated, it is used to provide network connectivity for the communication device 200. The connectivity is sometimes referred to as initial connectivity, even though it may not only be used to connect the first time.

The communication device 200 may be a consumer device with a user interface (UI). This user interface might be used to trigger initial connectivity and to trigger download of the operational profile. For example, an Activation Code (AC) obtained from the second mobile network (MNO2) when ordering the subscription may be used and where the AC is in the form of a Quick Response (QR) code that is scanned by the communication device 200 to obtain details needed for the profile download. Examples of such details are Matching ID, subscription manager address. The AC may also include data needed for using the eSIM bootstrap connectivity service to obtain initial connectivity or such information is obtained separately using the UI, for example, scanning another QR code.

The communication device 200 device may be an IoT device with limited UI or no UI at all and where profile download and profile management is remotely managed. Such a communication device 200 may be pre-configured from manufacturing by a manufacturer 800 (such as an eUICC Manufacturer (EUM) or an original equipment manufacturer (OEM)) with data needed for using the eSIM bootstrap connectivity service to obtain initial connectivity. The communication device 200 may also be configured with eSIM service information such that it can with help from the eSIM service download a suitable operational profile.

An eSIM server 300 represent an eSIM bootstrap connectivity service provider and provides an eSIM bootstrap connectivity service. Such a service might be provided to enterprises, IoT service providers, device owners, and end-users by the eSIM bootstrap connectivity service provider. The eSIM server 300 may or may not be part of a full eSIM service 600. The eSIM bootstrap connectivity service provider, and thus the eSIM server 300, is acting as the home operator for the communication devices 200 using the eSIM bootstrap connectivity service. The eSIM bootstrap connectivity service provider is either an MNO, a Mobile Virtual Network Operator (MVNO) or it has an agreement with an MNO (shown as MNO3 500c in the figures) that forwards network access authentication for the communication devices 200 to the eSIM server 300. In the first and second case, if SUPI is IMSI-based, the eSIM bootstrap connectivity service provider owns a Mobile Country Code and Mobile Network Code (MCC+MNC) combination and in the latter case the MCC+MNC of MNO3 is used.

An MNO is also known as a (Communications) Service Provider. (C)SP), and provides cellular connectivity for a communication device 200 and potentially also eSIM services for remote profile download. The eSIM bootstrap connectivity service provider, in case of being an MNO or MVNO, has roaming agreements with a set of MNOs (indicated as MNO1 in the figures) that assist in providing initial connectivity for the communication device 200 using the eSIM bootstrap connectivity service.

Enterprises. IoT service providers, device owners or end-users 700 that are using the eSIM bootstrap connectivity service orders profile(s) for their communication devices 200 from an MNO (shown as MNO2 in the figures), or when ordering profiles from an MNO the enterprises. IoT service providers. device owners or end-users are directed to use a particular eSIM bootstrap connectivity service for initial connectivity. This MNO interacts with the subscription manager 400, possibly with help from the eSIM server 300, for the preparation of operational profiles for remote download. Upon successful download and activation of the of an operational profile into a communication device 200, the MNO provides cellular connectivity for the communication device 200.

The subscription manager 400, e.g., an SM-DP+ or a Subscription Manager Discovery Server, handles profile download to communication devices 200 according to GSMA eSIM standards. The subscription manager 400 is either operated by the MNO providing the operational profile to be downloaded (MNO2 in the figures) or a third party trusted by the MNO.

As part of providing initial connectivity it is, in case where communication devices 200 are distributed globally over the world, necessary to determine the proper local MNO to provide the operational profile for a particular communication device 200 that is delivered to a particular geographical region. The process of determining the proper profile is referred to as the localization process. For example, based on geographical location of the communication device 200, knowledge of pre-negotiated agreements with MNOs, device information, etc., the proper MNO, provisioning server, and profile to be used are determined. Such localization may be offered as a service to enterprises/IoT service providers by an eSIM service provider.

There may be different ways in how the eSIM service is offered and how it is connected to the eSIM bootstrap connectivity service. In a first option the eSIM service is managing connectivity for a set of MNOs and handles the interaction with provisioning servers on behalf of the MNOs (the subscription manager 400 may even be offered by the eSIM service provider) and also updates/controls the HSS (or similar) of the MNO. In a second option the eSIM service is performing the localization based on input data and the enterprise itself is handling interaction with MNOs. Other options are also possible. The eSIM server 300 may either be closely connected to the eSIM service (or part of it), e.g. in the first option, or it may have no relation and only use a localization Application Programming Interface (API) to trigger localization. Such interaction may also be via the enterprise.

The embodiments disclosed herein relate to mechanisms for establishing network connection for a communication device 200 and assisting in establishing network connection for a communication device 200. In order to obtain such mechanisms there is provided a communication device 200, methods performed by the communication device 200, a computer program product comprising code, for example in the form of a computer program, that when run on processing circuitry of the communication device 200, causes the communication device 200 to perform the methods. In order to obtain such mechanisms there is further provided an eSIM server 300, methods performed by the eSIM server 300, and a computer program product comprising code, for example in the form of a computer program, that when run on processing circuitry of the eSIM server 300, causes the eSIM server 300 to perform the methods.

Some embodiments are presented in the context of communication device 200 comprising an identity module supporting the eSIM consumer variant. Some embodiments make use of the 5G EAP framework for authentication and 5G SUCI, and is leveraging eSIM credentials, both in the identity module and the subscription manager 400, for the authentication. Some embodiments allow an eSIM bootstrap connectivity service provider (e.g. a home operator, or eSIM service provider assisting MNOs and providing eSIM services to enterprises) to authenticate such a communication device 200 and the communication device 200 to authenticate the eSIM bootstrap connectivity service provider, without requiring any changes to the identity module or to the subscription manager 400. Some embodiments re-use the common mutual authentication of the eSIM consumer variant in the network access authentication. The common mutual authentication exchange of messages between the subscription manager 400 and the identity module is here tunneled within the 5G network control signaling, resulting in a new EAP method. In some embodiments, data exchanged in the methods is optimized such that the essential data can be exchanged using EAP-AKA′ messages. This requires some data to be pre-configured at the eSIM bootstrap connectivity service (i.e. MNO/eSIM service provider). In some embodiments, the common mutual authentication of the eSIM consumer variant is performed only once and leveraged both for the network access authentication for initial connectivity and for downloading a profile from the subscription manager 400, which saves the number of bits needed to be sent by the communication device 200. In this case the eSIM server 300 is remotely assisting in the profile download.

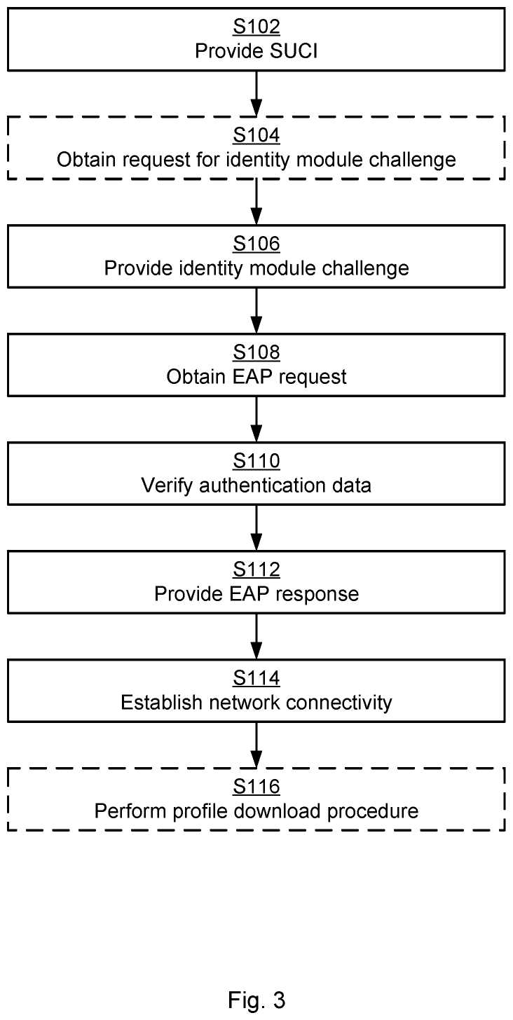

Reference is now made to FIG. 3 illustrating a method for establishing network connection for a communication device 200 as performed by the communication device 200 according to an embodiment. The communication device 200 comprises an identity module supporting remote subscription profile download.
S102, S106: The communication device 200 provides a SUCI, encrypted data comprising a device challenge, a public key of an ephemeral key pair of the communication device 200, and an identity module challenge towards an eSIM server 300. The encrypted data is based on an eSIM server public key and the ephemeral key pair of the communication device (200).
S108: The communication device 200 obtains a public key of an ephemeral key pair of the eSIM server 300, an SM challenge, an SM signature, and authentication data from the eSIM server 300 in an EAP request. The SM challenge and the SM signature are extracted from the authentication data. The SM signature has been computed on data comprising the identity module challenge.
S110: The communication device 200 verifies the authentication data to obtain proof of the eSIM server 300 knowledge of the device challenge. The verification of the received authentication data is performed using the public key of the ephemeral key pair of the eSIM server 300 and the device challenge. The SM signature is verified using the identity module and the identity module challenge as locally stored. An identity module signature computed on data comprising the received SM challenge is returned from the identity module upon successful verification.
S112: The communication device 200 provides S112 an EAP response towards the eSIM server 300. The EAP response comprises the identity module signature.
S114: The communication device 200 establishes network connectivity upon having obtained an EAP success message indicating successful authentication of the communication device 200.

Embodiments relating to further details of establishing network connection for a communication device 200 as performed by the communication device 200 will now be disclosed.

In some embodiments, the identity module challenge, the SM challenge, the SM signature, and the identity module signature follows a format used for handling remote subscription profile download to the identity module. In some embodiments, the SUCI comprises the encrypted data, a Message Authentication Code (MAC) over data comprising the device challenge, and the public key of the ephemeral key pair of the communication device 200. The MAC is based on an eSIM server public key and the ephemeral key pair of the communication device 200. In some embodiments, the device challenge provided in the encrypted data is the identity module challenge. In some embodiments, the encrypted data further is based on a device identifier of the communication device 200. In some examples, the device identifier is provided in an encrypted part of the SUCI.

In some embodiments, at least one of the encrypted data, the public key of the ephemeral key pair of the communication device 200, the identity module challenge and a device identifier of the communication device 200 is provided separately from the SUCI, and the communication device 200 is configured to perform (optional) step S104:
S104: The communication device 200 obtains a request from the eSIM server 300 for at least one of the encrypted data, the public key of the ephemeral key pair of the communication device 200, the identity module challenge and the device identifier upon having provided the SUCI. At least one of the encrypted data, the public key of the ephemeral key pair of the communication device 200, the identity module challenge and the device identifier is provided towards the eSIM server 300 in response thereto.

The identity module challenge and/or the device identifier might be provided in encrypted data. In some examples, the at least one of the encrypted data, the public key of the ephemeral key pair of the communication device 200, the identity module challenge and the device identifier provided in response to the request from the eSIM server 300 is provided towards the eSIM server 300 formatted as a SUCI. The identity module identifier (such as the eUICC Identifier; EID), might be used as device identifier of the communication device 200. The ephemeral key pair of the communication device 200 might be generated by the communication device 200. The identity module might comprise credentials for remote subscription profile download. The identity module might be an eUICC. The credentials might be used for generating the identity module signature. The eSIM server public key might be stored by the communication device 200.

In some embodiments, the authentication data comprises aMAC. The verifying then comprises calculating a MAC using the public key of the ephemeral key pair of the eSIM server 300, and the device challenge, and comparing the calculated MAC to the MAC received in the authentication data. In this respect, either the MAC is computed on the public key of the ephemeral key pair of the eSIM server 300 using the device challenge as key, or the MAC is computed on the device challenge using a MAC key, and where the MAC key is derived from an Elliptic Curve Diffie-Hellman (ECDH) shared secret derived using the ephemeral key pair of the eSIM server 300 and the ephemeral key pair of the communication device 200. In the latter case, the ECDH shared key is derived at the eSIM server 300 using the private key of the ephemeral key pair of the eSIM server 300 and the public key of the ephemeral key pair of the communication device 200, and at the communication device 200 using the private key of the ephemeral key pair of the communication device 200 and the public key of the ephemeral key pair of the eSIM server 300. In general terms, verification of a received MAC involves computing the MAC and comparing it to the received MAC. When the communication device 200 is calculating the MAC the public key of the ephemeral key pair of the eSIM server 300 is used. Successful verification of the received MAC ensures that the received public key of the ephemeral key pair of the eSIM server 300 is not tampered with.

In some embodiments, the authentication data comprises the device challenge encrypted using an encryption key derived using the public key of the ephemeral key pair of the eSIM server 300 and the private key of the ephemeral key pair of the communication device 200. In particular, the encryption key is derived from an ECDH shared secret derived using the ephemeral key pair of the eSIM server 300 and the ephemeral key pair of the communication device 200. The ECDH shared key is derived at the eSIM server 300 using the private key of the ephemeral key pair of the eSIM server 300 and the public key of the ephemeral key pair of the communication device 200, and at the communication device 200 using the private key of the ephemeral key pair of the communication device 200 and the public key of the ephemeral key pair of the eSIM server 300. The verifying of the authentication data then comprises decrypting the device challenge and comparing it to the device challenge as locally stored. Successful comparison of the decrypted device challenge to the locally stored device challenge ensures that the received public key of the ephemeral key pair of the eSIM server 300 is not tampered with.

In some embodiments, the SM challenge and/or the SM signature in the authentication data are encrypted using an encryption key. The verifying then comprises deriving the encryption key using the public key of the ephemeral key pair of the eSIM server 300 and the private key of the ephemeral key pair of the communication device 200, wherein the derivation of the encryption key is according to the above description, and decrypting, using the derived encryption key, the encrypted SM challenge and/or SM signature prior to verifying the SM signature. In particular, in case the device challenge is the identity module challenge, successful verification of the SM signature, using the identity module challenge as locally stored, provides proof of the eSIM server 300 knowledge of the device challenge and ensures that the received public key of the ephemeral key pair of the eSIM server 300 is not tampered with.

In some aspects, common mutual authentication between the subscription manager 400 and the communication device 200 is performed once and serves the purpose of both network access authentication for initial connectivity and mutual authentication for profile download. Particularly, in some embodiments, the communication device 200 is configured to perform (optional) step S116:
S116: The communication device 200 performs a profile download procedure with a subscription manager 400 (where the subscription manager is a provisioning server, such as an SM-DP+) via the eSIM server for downloading an operational subscription profile from the subscription manager 400 to the identity module of the communication device 200 without further authentication with the subscription manager 400.

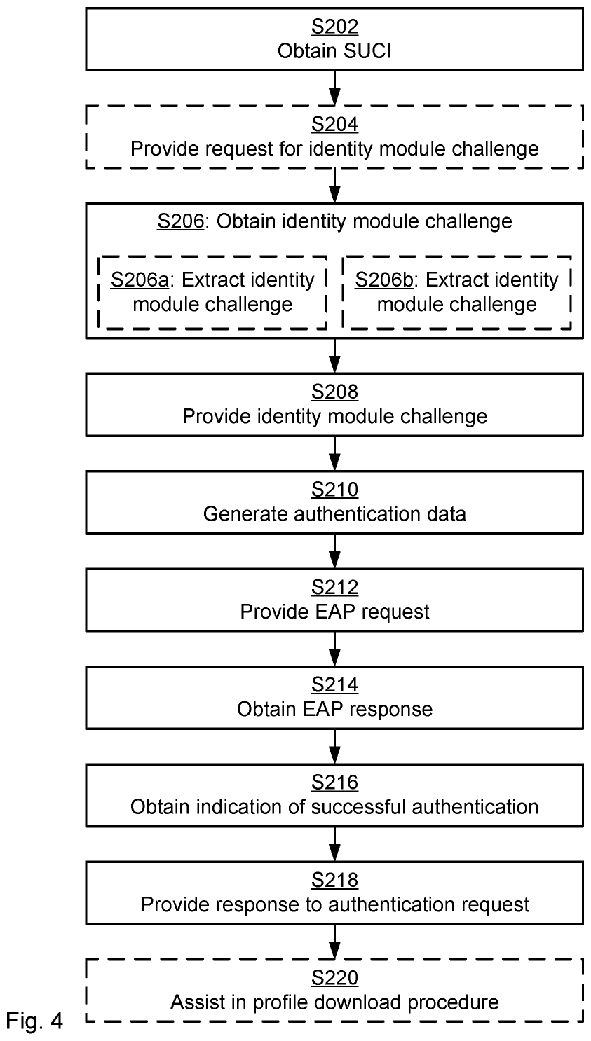

Reference is now made to FIG. 4 illustrating a method for assisting in establishing network connection for a communication device 200 as performed by the eSIM server 300 according to an embodiment.
S202, S206: The eSIM server 300 obtains a SUCI, encrypted data comprising a device challenge, a public key of an ephemeral key pair of the communication device 200, and an identity module challenge from the communication device 200. The encrypted data is based on an eSIM server public key and the ephemeral key pair of the communication device 200.
S208: The eSIM server 300 provides the identity module challenge to a subscription manager 400 over a secure communication channel established between the eSIM server 300 and the subscription manager 400. Further, the eSIM server 300 receives an SM challenge and an SM signature computed by the subscription manager 400 on data comprising the identity module challenge in return from the subscription manager 400.
S210: The eSIM server 300 generates authentication data using an ephemeral key pair of the eSIM server 300. The authentication data provides proof of the eSIM server 300 knowledge of the device challenge. The authentication data comprises the SM challenge and the SM signature.
S212: The eSIM server 300 provides an EAP request towards the communication device 200. The EAP request comprises a public key of the ephemeral key pair of the eSIM server 300 and the authentication data.
S214: The eSIM server 300 obtains an EAP response from the communication device 200 in an authentication request. The EAP response comprises an identity module signature.
S216: The eSIM server 300 obtains an indication of successful authentication of the communication device 200, wherein successful authentication of the communication device 200 comprises successful verification of the identity module signature.
S218: The eSIM server 300 providing, upon having obtained the indication of successful authentication of the communication device 200, a response to the authentication request towards the communication device 200. The response comprises an EAP success message indicating successful authentication of the communication device 200 for network connectivity to be established with the communication device 200.

Embodiments relating to further details of assisting in establishing network connection for a communication device 200 as performed by the eSIM server 300 will now be disclosed.

In some embodiments, the identity module challenge, the SM challenge, the SM signature, and the identity module signature, follows a format used for handling remote subscription profile download to the identity module.

In some embodiments, the SUCI comprises the encrypted data, a MAC over data comprising the device challenge, and the public key of the ephemeral key pair of the communication device 200. The MAC is based on an eSIM server public key and the ephemeral key pair of the communication device 200.

The device challenge might be received from the communication device 200 in the encrypted data is the identity module challenge.

The encrypted data might further be based on a device identifier of the communication device 200. In some examples, the device identifier is provided in the encrypted part of the SUCI.

In some embodiments, the eSIM server 300 is configured to perform (optional) step S206a as part of step S206:
S206a: The eSIM server 300 extracts the device challenge and/or identity module challenge from the SUCI upon having decrypted the encrypted data of the SUCI and verified the MAC of the SUCI. The SUCI is decrypted and verified using the eSIM server private key, and the public key of the ephemeral key pair of the communication device 200 obtained from the SUCI.

In some embodiments, at least one of the encrypted data, the public key of the ephemeral key pair of the communication device 200, the identity module challenge and a device identifier of the communication device 200 is obtained separately from the SUCI, and the eSIM server 300 is configured to perform (optional) step S204 before step S206:
S204: The eSIM server 300 provides a request towards the communication device 200 for at least one of the encrypted data, the public key of the ephemeral key pair of the communication device 200, the identity module challenge, and the device identifier, upon having obtained the SUCI. At least one of the encrypted data, the public key of the ephemeral key pair of the communication device 200, the identity module challenge and the device identifier is obtained from the communication device 200 in response thereto.

In some embodiments, the identity module challenge and/or device identifier is obtained in encrypted data, and the eSIM server 300 is configured to perform (optional) step S206b as part of step S206:
S206b: The eSIM server 300 extracts the device challenge and/or identity module challenge by decrypting the encrypted data.

The ephemeral key pair of the eSIM server 300 might be generated by the eSIM server 300. The eSIM server private key might be stored by the eSIM server 300.

In some embodiments, the indication of successful authentication is obtained by the eSIM server 300 itself verifying the identity module signature. In some embodiments, the indication of successful authentication is obtained by the eSIM server 300 sending the identity module signature to the subscription manager 400 for verification and in return receiving a result of successful authentication from the subscription manager 400.

In some embodiments, the authentication data comprises a Message Authentication Code (MAC) calculated using the ephemeral key pair of the eSIM server 300 and the device challenge. In this respect. either the MAC is computed on the public key of the ephemeral key pair of the eSIM server 300 using the device challenge as key, or the MAC is computed on the device challenge using a MAC key, and where the MAC key is derived from an ECDH shared secret derived using the private key of the ephemeral key pair of the eSIM server 300 and the public key of the ephemeral key pair of the communication device 200.

In some embodiments, the authentication data comprises a device challenge encrypted using an encryption key derived using the private key of the ephemeral key pair of the eSIM server 300 and the public key of the ephemeral key pair of the communication device 200.

In some embodiments, the SM challenge and/or the SM signature in the authentication data are encrypted using an encryption key derived using the private key of the ephemeral key pair of the eSIM server 300 and the public key of the ephemeral key pair of the communication device 200.

As disclosed above, in some aspects, common mutual authentication between the subscription manager 400 and the communication device 200 is performed once and serves the purpose of both network access authentication for initial connectivity and mutual authentication for profile download. Particularly, in some embodiments, the eSIM server 300 is configured to perform (optional) step S220:
S220: The eSIM server 300 assists in a profile download procedure for the communication device 200 and the subscription manager 400 (where the subscription manager is a provisioning server, such as an SM-DP+) for an operational subscription profile to be downloaded from the subscription manager 400 to the identity module of the communication device 200 without further authentication between the communication device 200 and the subscription manager 400.

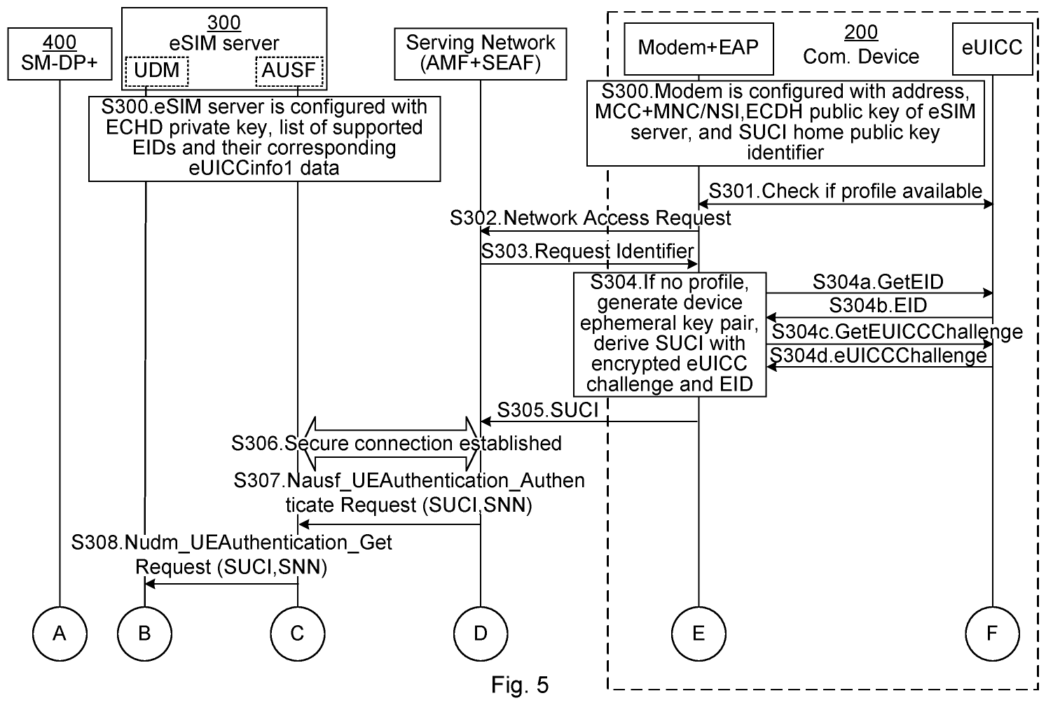

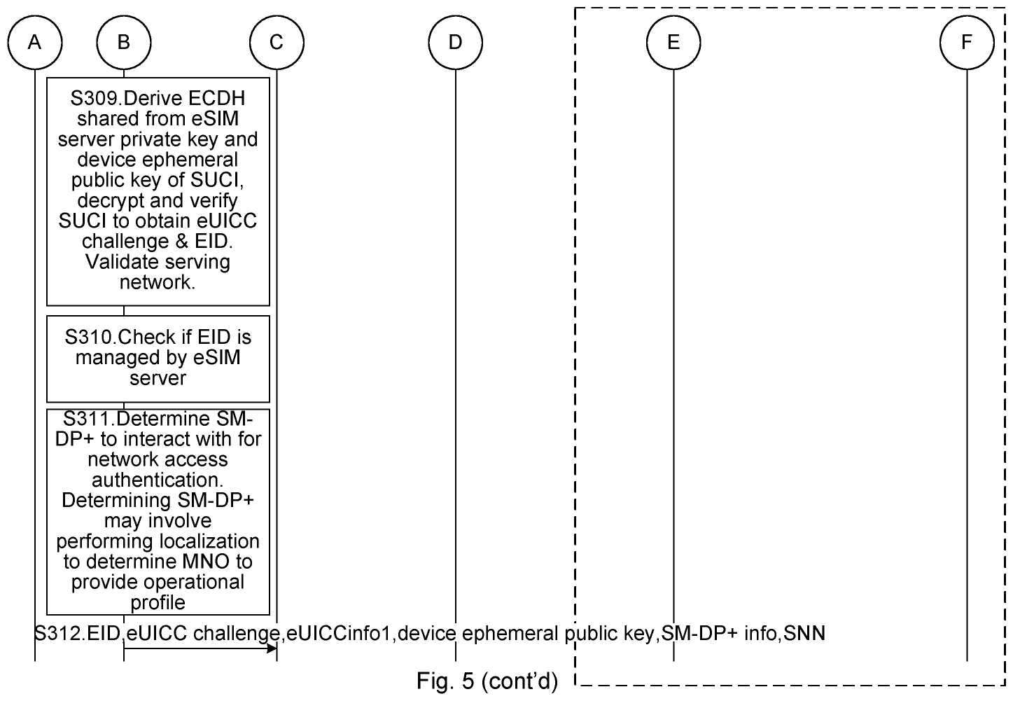

An embodiment for initiating 5G network access authentication based on at least some of the above disclosed embodiments will now be disclosed in detail with reference to the signalling diagram of FIG. 5.

In 5G networks, in order to protect subscriber privacy, the Subscription Permanent Identifier (SUPI), such as IMSI, is encrypted, and called SUCI, when delivered from the communication device 200 to the home network represented in FIG. 5 by the eSIM server 300. The encryption is performed leveraging a long-term elliptic curve (EC) public key of the home operator and the EC private key of an ephemeral EC key pair generated at the communication device 200. The format of the SUCI and what part is encrypted depends on the SUPI type. In case of the SUPI being based on the IMSI, only the MSIN part (IMSI excluding MCC+MNC) of the IMSI is encrypted and the MCC+MNC are not encrypted for routing purposes. If the SUPI is a Network Specific Identifier (NSI), the SUCI is in a Network Access Identifier (NAI) format, i.e. username@realm, where only the username part is encrypted. Here the realm part is not encrypted for routing purpose. Private networks (also known as standalone non-public networks) may have the SUCI in NAI format and the domain name (part of the realm) may then include the MCC, MNC, and a Network Identifier (NID) of the private network.
S300: The eSIM server long term EC public key is configured in the communication device 200 (e.g. in the modem of the communication device 200 or in the eUICC). The communication device 200 is also configured with the address of the eSIM server 300, SUPI information of the eSIM server 300, SUCI routing indicator, and the SUCI home public key identifier to be used. The SUPI information is either the MCC+MNC value to be used if the SUPI is based on the IMSI, or a realm/domain name if using an NSI-based SUPI. The eSIM server 300 is configured with the corresponding long-term EC private key and a list of device identifiers (e.g. eUICC Identifier) belonging to communication devices 200 currently using the eSIM server 300. For each device identifier the eUICCInfo1 data for the eUICC is stored. This is a data common for a batch of communication devices 200. If the eUICC Identifier (EID) is not used as device identifier, the eSIM server may also store its EID.
S301: In order to attach to a network at first wake-up of the communication device 200, the modem of the communication device 200 checks if there is a profile available in the eUICC. It is here assumed that there is not any profile available.
S302: The modem scans for available networks to attach to. The modem analyzes the available networks and determines MNO1 as a suitable one., e.g. based on configured SUPI information such as MCC+MNC. MNO1 is the serving network in FIG. 5. The modem then requests to attach to the selected network.
S303: An identity request is provided from the serving network. The 5G Access and Mobility management Function, AMF, (and involving also the Security Anchor Function, SEAF) of the serving network handle the interaction with the communication device.
S304: The modem retrieves the device identifier (e.g. EID) and eUICC challenge from the eUICC. The modem calculates the SUCI following standard 5G SUCI generation where an ephemeral EC key pair is generated at the communication device 200 and used in the SUCI generation, the MCC+MNC or NSI realm/domain name is included in the SUCI, but where the concealed part of SUCI is the concatenation of the device identifier (e.g. EID) and the 16-byte eUICC challenge. The EID (if used) and eUICC challenge are requested by the modem from the eUICC.
S305: The generated SUCI is delivered to the serving network.
S306: The serving network analyzes the SUCI to determine the home mobile network based on MCC+MNC or NSI realm/domain name. Secure communication with the home network is established (secure roaming interface).
S307: A roaming request is performed to the home network in which an authentication request is performed to the 5G Authentication Server Function, AUSF, in which SUCI is provided as identifier of the communication device 200 along with the serving network name (SNN). The home network is either the eSIM server 300 acting as an MVNO, or the home network is another mobile network operator, represented by MNO3.
S308: The AUSF of the home network forwards the authentication request to the 5G Unified Data Management (UDM) of the home network.
S309: The UDM of the home network analyzes the routing indicator and/or the home public key identifier of the SUCI. In case the home network is MNO3 and not the eSIM server 300 the SUCI and authentication request is forwarded to the UDM of the eSIM server 300 along with the SNN. The routing indicator and/or home public key identifier is used to indicate to MNO3 if the authentication request including SUCI is to be processed by MNO3 or if it is to be forwarded to the UDM of the eSIM server 300. The UDM of the eSIM server 300 uses its long-term EC private key and received ephemeral EC public key of the device from SUCI to derive an ECDH shared secret, derive session keys, and decrypt and verify the SUCI to obtain the device identifier (e.g. EID) and eUICC challenge. As an optional step, the eSIM server 300 may validate based on the MCC+MNC from the SNN whether the serving network is allowed to request the eSIM bootstrap service.
S310: The eSIM server 300 checks in its database whether the device identifier (e.g. EID) is present as identifier of a device currently using the eSIM server 300.
S311: The eSIM server 300 determines what subscription manager 400 to use for the network access authentication. This may be either a predefined subscription manager 400, or, if network access authentication is combined with profile download and the eSIM service is used, localization to determine the MNO to provide the operational profile may be performed and as part of that localization the proper target subscription manager 400 to use is thereby determined.
S312: The AUSF of the eSIM server 300 that performs the network access authentication receives the device identifier (e.g. EID), eUICC challenge, eUICCInfo1, device ephemeral EC public key, information about what subscription manager 400 to connect to (e.g. SM address), and serving network name (SNN). The SNN is constructed from MCC+MNC of serving network (and optionally also Network identifier (NID) in case of private network). Examples of SNN are 5G:mnc015.mcc234.3gppnetwork.org (or 5G:mnc015.mcc234.3gppnetwork.org:123456ABCDE where NID=123456ABCDE).

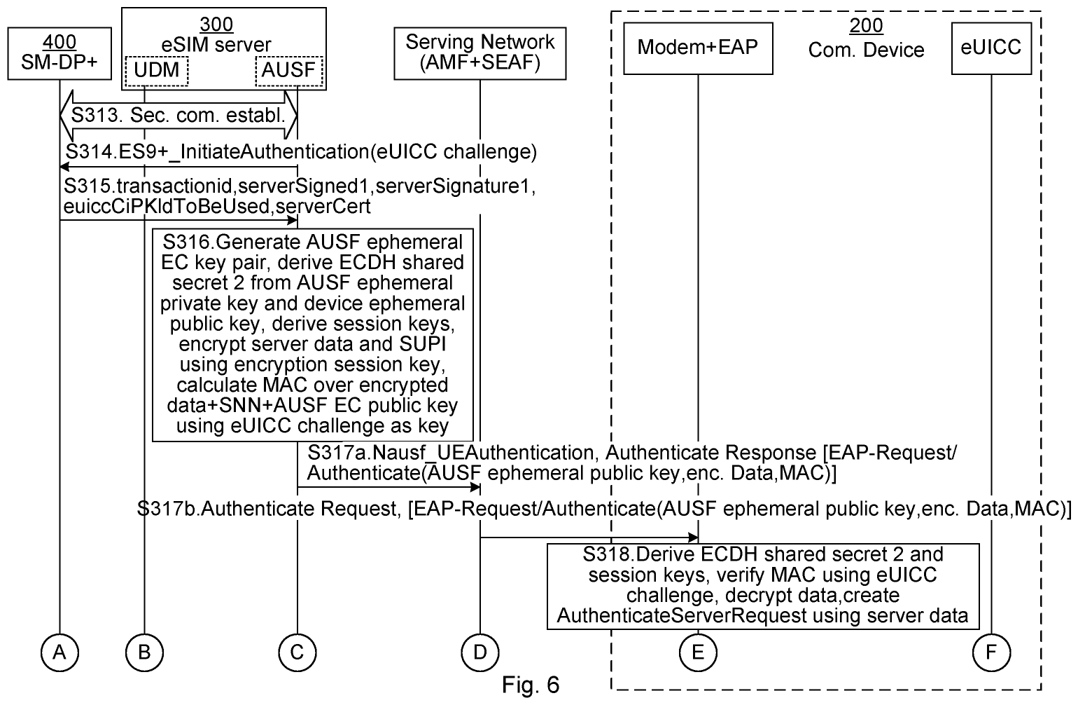

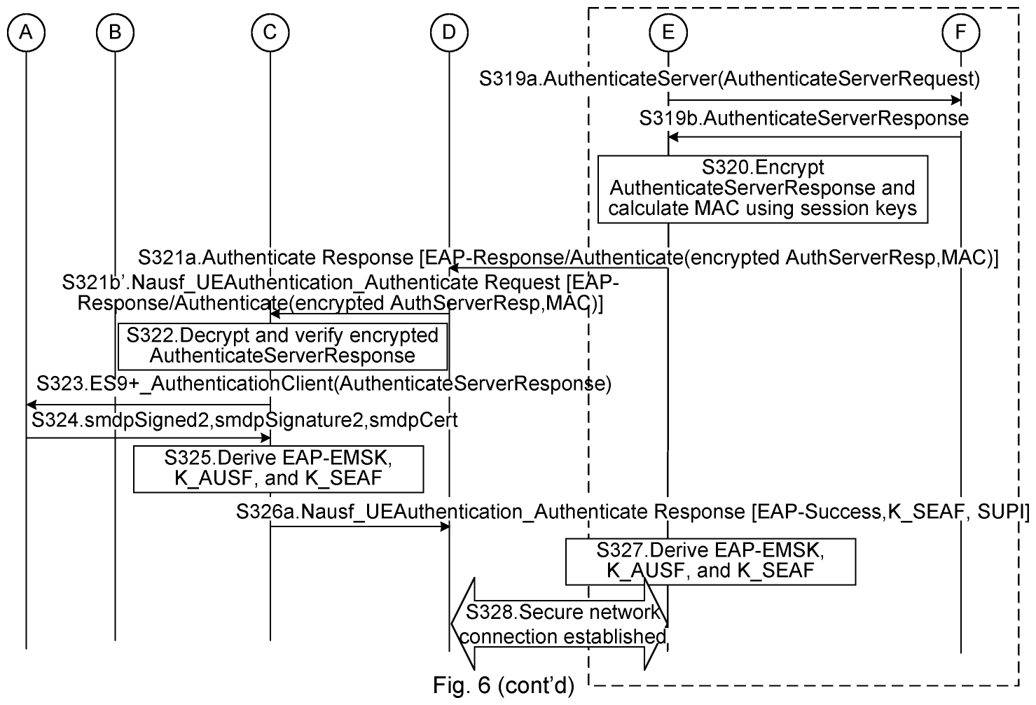

The AUSF of the eSIM server 300 is now ready to perform the network access authentication which is detailed in FIG. 6.

An embodiment for 5G network access authentication using EAP framework and eSIM credentials based on at least some of the above disclosed embodiments will now be disclosed in detail with reference to the signalling diagram of FIG. 6.
S313: The AUSF of the eSIM server 300 establishes secure communication using Hypertext Transfer Protocol Secure (HTTPS) with the selected subscription manager 400 following the GSMA consumer eSIM standard. The AUSF is configured with Certificate Issuer (e.g. GSMA) root certificate for validation of the SM TLS certificate as part of establishing the secure communication. The GSMA eSIM ES9+ interface is used for the communication between the eSIM server 300 and the subscription manager 400.
S314: An ES9+_InitiateAuthentication command is sent to the subscription manager 400 where the eUICC challenge and eUICCInfo1 are provided along with the SM address.
S315: Following the GSMA eSIM consumer standard, the subscription manager 400 signs the eUICC challenge and other server data and responds with transactionId, serverSigned1, serverSignature1, euiccCiPKIdToBeUsed, and serverCertificate.
S316: The AUSF of the eSIM server 300 generates an AUSF ephemeral EC key pair and derives the ECDH shared secret from the AUSF ephemeral EC private key and the device ephemeral EC public key. This secret is referred to as ECDH shared secret 2. Session keys are from ECDH shared secret 2, e.g. using SHA-256 hash and a fixed string: encryption key and MAC key. A SUPI (e.g. IMSI) is selected for use as a temporary SUPI by the communication device 200 until an operational profile is downloaded and enabled. The server data concatenated with the SUPI is then encrypted using the encryption key. A MAC over the encrypted data, the serving network name (SNN), and the AUSF ephemeral public key is then calculated using the eUICC challenge as a key.
S317: Following 5G EAP-based authentication an EAP-Request is sent from AUSF back of the eSIM server 300 to the serving network as a response to step S307 of FIG. 5 and that is forwarded to the communication device 200. The EAP-Request contains the AUSF ephemeral public key, the serving network name (SNN), the encrypted data, and MAC.
S318: The modem/EAP module derives the ECDH shared secret 2 using the device ephemeral private key and the received AUSF ephemeral public key, and then derive the session keys for encryption and MAC. The communication device 200 verifies the MAC using the eUICC challenge as a key and if successful verification it decrypts the encrypted data. The communication device 200 then creates the AuthenticateServerRequest structure using the server data. SUPI and SNN are stored for later use.
S319: The modem calls the eUICC ES10 AuthenticateServer function that performs server (SM) authentication by verifying the serverSignature1 and checking the signed challenge is the one stored internally. If successful verification, the function prepares data called AuthenticateServerResponse for the subscription manager 400 to authenticate the eUICC. This data contains the eUICC signature on, among other things, the server challenge (that is part of serverSigned1 in AuthenticateServerRequest). The AuthenticateServerResponse is returned to the modem.
S320: The modem encrypts the AuthenticateServerResponse and computes a MAC on the encrypted data using the session keys.
S321: In response to the authentication request received in step S317b, the modem returns an EAP-Response message containing the encrypted AuthenticateServerResponse and the MAC. The serving network includes the EAP-Response message in an authentication request to the AUSF of the eSIM server 300.
S322: The AUSF of the eSIM server 300 verifies the MAC and decrypts the encrypted data. If EID is used as device identifier or if the EID can be looked up in the eSIM server database based on the device identifier, the eSIM server 300 parses the AuthenticateServerResponse to extract the EID and checks that it matches the EID received in step S312.
S323: An ES9+_AuthenticationClient command is sent to the subscription manager 400 where the AuthenticateServerResponse is provided.
S324: The subscription manager 400 authenticates the communication device 200 by verifying eUICC signature in the AuthenticateServerResponse. If successful verification, the subscription manager 400 prepares smdpSigned2 (with data for profile download preparation) and smdpSignture2. The subscription manager 400 returns smdpSigned2, smdpSignature2, and smdpCert to the AUSF of the eSIM server 300.
S325: If the AUSF receives smdp data it knows the communication device 200 was successfully authenticated and the AUSF then derives EAP-EMSK, K_AUSF, and K_SEAF. EAP-EMSK is derived from the ECDH shared secret 2, K_AUSF is derived from EAP-EMSK, and K_SEAF is derived from K_AUSF. SNN is used in the derivation of SEAF.
S326: The AUSF sends a response to the authentication request received in step S321b containing an EAP-Success message, K_SEAF, and the selected SUPI. The serving network forwards the EAP-Success message to the communication device 200.
S327: Based on knowledge of successful authentication the modem derives EAP-EMSK, K_AUSF, and K_SEAF. SNN is used in the derivation of SEAF.
S328: The communication device 200 follows a standard 5G procedure for deriving various keys in the key hierarchy and establishes secure connection with the serving network.

In the above flow a temporary SUPI (e.g. IMSI) is delivered to the communication device 200 (obtained in step S318) and the serving network (obtained in step S326) for use until the operational profile is downloaded. This SUPI is one from a range of SUPIs that the eSIM server 300 uses (e.g. licenses from MNO3) for temporary SUPIs for the communication devices 200 using the eSIM server 300. The SUPIs belonging to this range are under the control of the eSIM server 300 and are frequently reused as soon as an operational profile download has occurred. The temporary SUPIs may, for example, be recycled after a certain period of time within which the communication device 200 is expected to have downloaded a profile. Alternatively, the eSIM server 300 may be notified by the MNO, or the communication device 200 itself when the operational profile download has occurred. The same SUPI can potentially be used with different serving networks simultaneously and still avoid collisions since the communication device 200 will typically never present this SUPI.

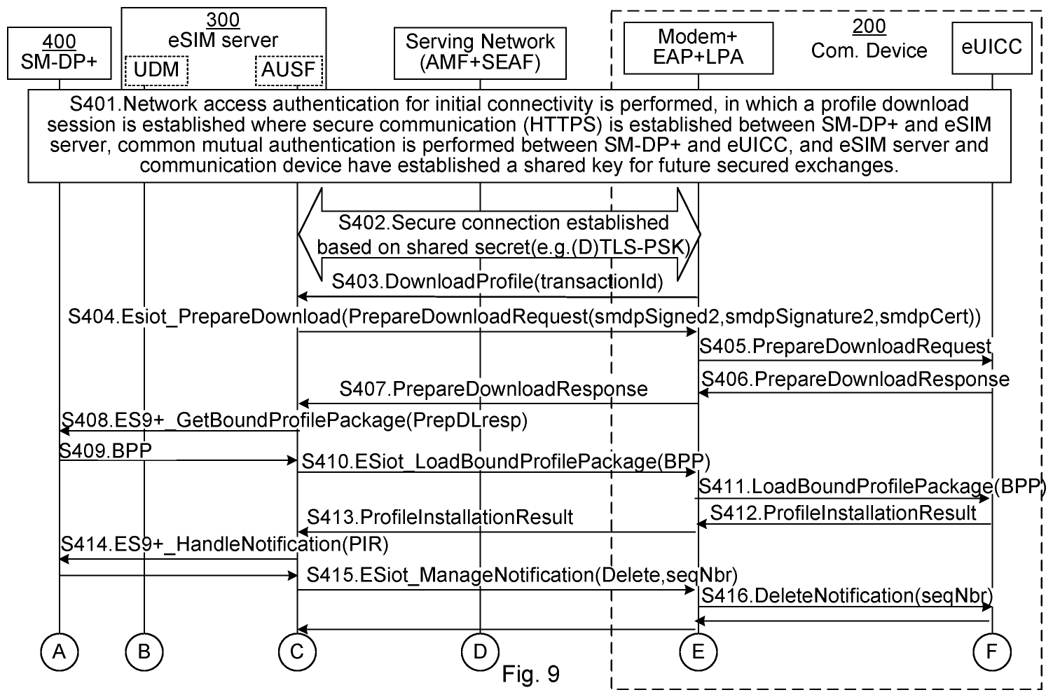

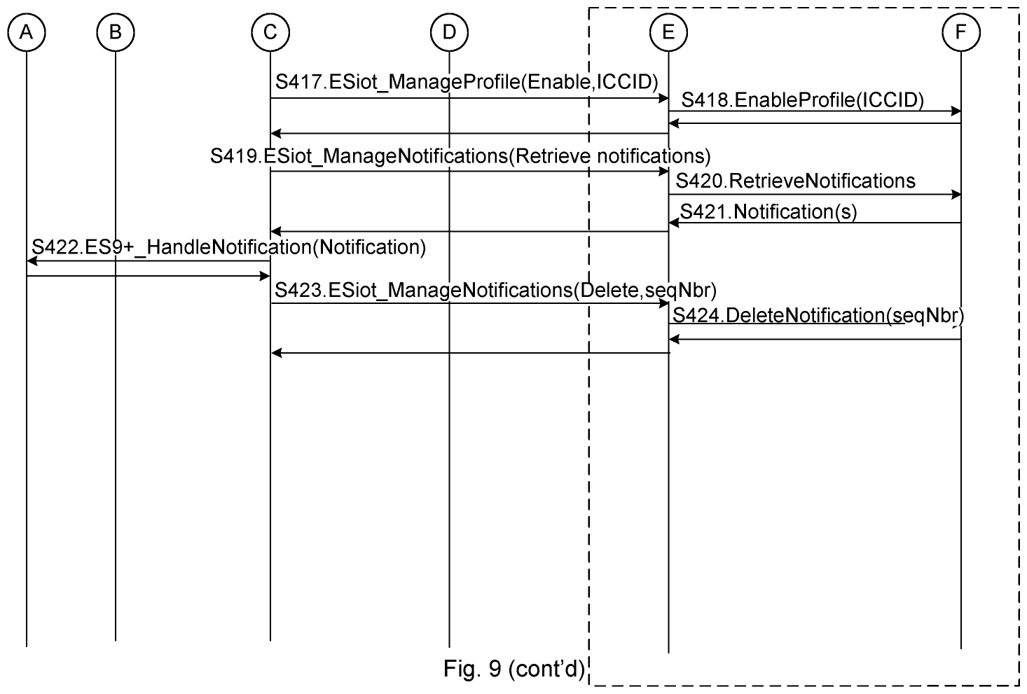

The methods in FIG. 5 and FIG. 6 might be combined with a continuation as in FIG. 9 where the operational profile download is performed within the already started session with the subscription manager 400. There is also the possibility that a profile download will not follow. This variant will also be described below.

In FIG. 5 and FIG. 6 there is both a serving network and a home network and roaming between the two networks. It can be that the serving network is in fact the home network and there is no roaming (and thus step S306 disappears). The AMF and SEAF of the serving network in FIG. 5 and FIG. 6 are now the corresponding entities of the home network.

FIG. 5 and FIG. 6 ensure mutual authentication between the communication device 200 and the 5G network represented by the eSIM server 300 and prevents man-in-the-middle attacks. The eUICC challenge serves as a challenge for the communication device 200 to authenticate the eSIM server 300. The communication device 200 is configured with the long-term public key of the eSIM server 300 and is used to encrypt the eUICC challenge as part of SUCI. Only the legitimate eSIM server 300 has the corresponding private key and can decrypt SUCI and obtain the eUICC challenge. The eUICC challenge is signed by the subscription manager 400 and the SM signature over the eUICC challenge is verified by the eUICC. The eUICC challenge is also used as a MAC key to protect integrity of SM data and the eSIM server public key. The eUICC challenge is never sent in clear between the communication device 200 and the eSIM server 300.

The eSIM server 300 authenticates the communication device 200 with help of the eUICC of the communication device 200. By verifying the eUICC signature being part of the AuthenticateServerResponse the eSIM server 300 ensures the eUCC of the communication device 200 is legitimate and it can also check that the EID of the eUICC is part of the list of EIDs that is using the service. The verification of the eUICC signature can either be made by the eSIM server 300 itself or the subscription manager 400 performs the verification on behalf of the eSIM server 300 as is shown in FIG. 6.

As noted above, the network access authentication for initial connectivity may be performed without a continuation according to FIG. 9, i.e. without any operational profile download within the already started session with the subscription manager 400. In this case the profile download may be performed later with a complete, new session from the device. Another alternative is described below where the method is used as permanent authentication method. There are then a few differences compared to the methods in FIG. 5 and FIG. 6. The communication device 200 is configured to only perform the network access authentication and will send an ES10 CancelSession command to the eUICC at any point after step S319 to reset the eUICC state. At the server side, after receiving the response of successful authentication of the eUICC in step S324, the eSIM server 300 drops the connection with the subscription manager 400 and ignores the data returned in step S324. This will indicate to the subscription manager 400 that something went wrong, and the pending session is interrupted/abandoned.

In FIG. 5 and FIG. 6 it is assumed that a profile download preparation is performed over ES2+ with the subscription manager 400 such that the subscription manager 400 is ready to download a profile for the particular communication device 200. In particular, in step S324 according to the eSIM consumer standard, the subscription manager 400 will check that it has a profile prepared for download for the particular EID or Matching ID included in the AuthenticateServerResponse. Assume a Matching ID is used for identifying the profile at the subscription manager 400 during the profile download preparation but that no binding to a particular eUICC with a particular EID is done. Then, the profile will be bound to the EID when the subscription manager 400 performs step S324. When dropping the connection, the subscription manager 400 will regard this as an unsuccessful download attempt and will allow a new download attempt later from the same eUICC (with the same EID).

In one variant of FIG. 5 and FIG. 6, the verification of the AuthenticateServerResponse is performed by the eSIM server 300 itself following step S322 instead of (or in addition to) performing steps S323 and S324 where the SM performs the verification. The eSIM server 300 is provisioned with the GSMA Certificate Issuer (CI) root certificate used in the verification. This variant can be used when there is not any continuation to download the profile. This variant also avoids binding a profile to the EID, if not already done during profile download preparation, until the actual download of the profile is to be performed. In fact, this alternative avoids the need to have a profile prepared for the particular communication device 200 at all since the subscription manager 400 will never try to link the signed AuthenticationServerResponse from the eUICC to any profile.

In one variant of FIG. 5 and FIG. 6, when there is not any continuation to download a profile, an SM-DS is used instead of the SM. The SM-DS performs the same common mutual authentication as performed by the SM in FIG. 6. Upon successful authentication of the communication device 200 by verifying the eUICC signature in the AuthenticateServerResponse in step S324, the SM-DS checks if there are pending event records for the particular eUICC of the communication device 200, matching either the EID or the Matching ID of the AuthenticateServerResponse. If such event records exist, they are returned to the eSIM server 300, and the eSIM server 300 can conclude that the communication device 200 was successfully authenticated. If such event records do not exist, an appropriate status is returned to the eSIM server 300, and the eSIM server 300 can depending on the status determine whether the communication device 200 was successfully authenticated or not. The variant using an SM-DS instead of the SM may be combined with the variant above where the verification of the AuthenticateServerResponse is performed by the eSIM server 300 itself following step S322.

In one variant the eUICCInfo1 of each communication device 200 is not known beforehand by the eSIM server 300 but is part of the encrypted SUCI, i.e., the eUICCInfo1 is encrypted along with the EID and eUICC challenge.

In general terms, after receiving the SUCI in step S305, the serving network needs to analyze the SUCI to determine the home network. For example, in case of IMSI-based SUPI the serving network needs to parse the SUPI to extract MCC+MNC of the home network. Depending on the type of SUPI and protection scheme the SUCI can be of varying length. However, in the case of IMSI-based SUPI and using a particular protection scheme the SUCI will have a certain length and format, as follows.
Byte 1: Denotes SUPI type is IMSI (value of byte is 1).
Byte 2-4: Identifies the home network (i.e. encoding of MCC and MNC).
Byte 5-6: A routing indicator used to route within home network.
Byte 7: Denotes the SUPI protection scheme.
Byte 8: Denotes the home network public key identifier.
Byte 9 and onwards: denote the protected SUPI and depend on the protection scheme used. For the standardized schemes, except for the null scheme, the scheme output consists of the public key from an ephemeral elliptic curve key pair generated by the communication device 200 followed by the encrypted SUPI (IMSI except for MCC and MNC) and a MAC calculated on the ephemeral public key and the encrypted SUPI. The encryption and MAC keys used to encrypt SUPI and to generate the MAC are derived from the ephemeral elliptic curve private key and a home network public key.

In particular, with the currently standardized protection schemes (profile A and profile B) the length of the encrypted data in SUCI is 5 bytes resulting from encrypting the MSIN part of the IMSI (the part of IMSI excluding MCC+MNC which is only 5 bytes).

If the home network operator uses a proprietary protection scheme, the format of byte 9 and onwards of the SUCI is only known to the home network operator.

The method disclosed with reference to FIG. 5 and FIG. 6 can be used as initial connectivity for private 5G networks. One option is to use the method for permanent network access authentication in private 5G networks. In particular, for communication devices 200 that are used in both private and public networks, and where the communication devices 200 is already equipped with an eUICC for the consumer eSIM version, the eUICC may contain an operational subscription profile for accessing a public network, whereas the permanent network access authentication for the private network is based on the method disclosed with reference to FIG. 5 and FIG. 6. In this case the eSIM server 300 becomes an eSIM (permanent) connectivity server.

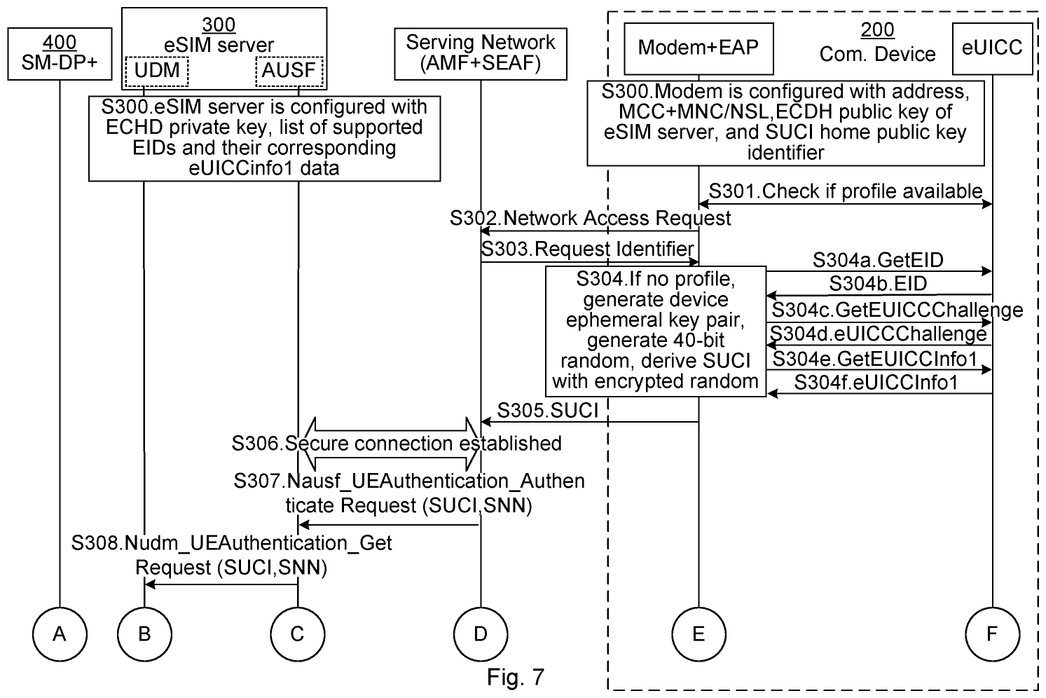

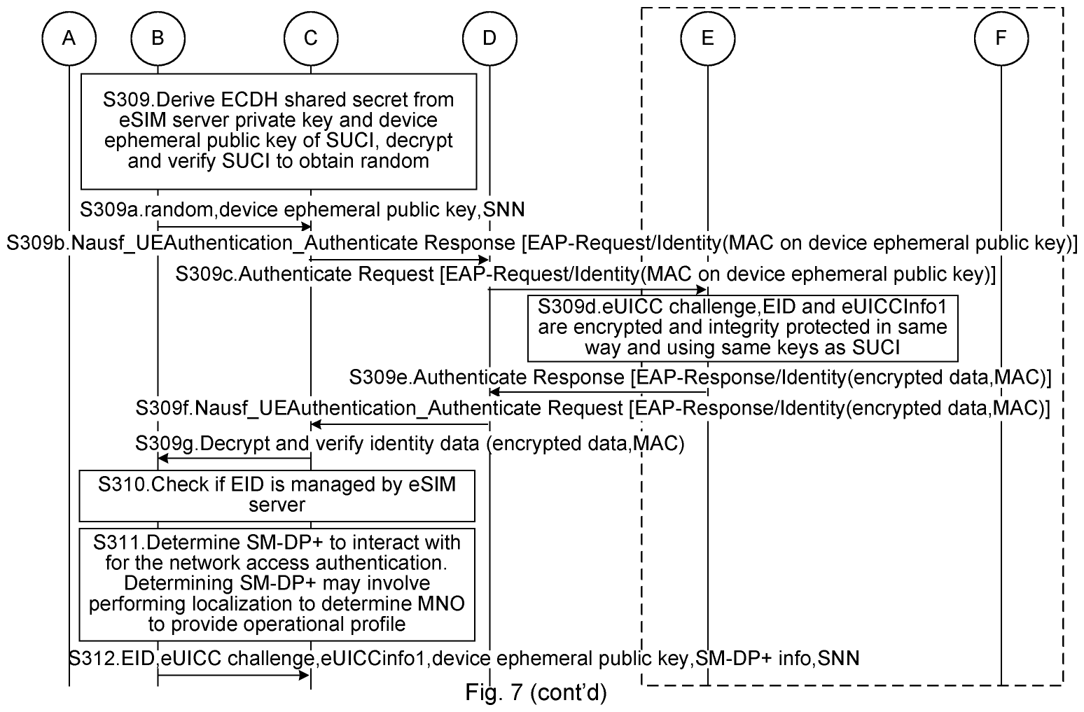

An embodiment for initiating 5G network access authentication with extra EAP round based on at least some of the above disclosed embodiments will now be disclosed in detail with reference to the signalling diagram of FIG. 7.

In some variants of FIG. 5, the serving network is assumed to thoroughly examine the format of SUCI before forwarding it to the home network in step S307. As part of this, for any non-proprietary protection scheme, the serving network will block any SUCI where SUPI is based on IMSI and where the length of the encrypted data is not equal to 5 bytes. None of the items eUICC challenge, EID, and eUICCInfo1 can then be sent as part of the SUCI. This can be overcome by introducing an extra EAP round in step S309 as shown in FIG. 7.

The method in FIG. 7 differs from the method in FIG. 5 in steps S304 and S309. In step S304 a 5-byte (40-bit) random-valued sequence is encrypted instead of the eUICC challenge and EID. This random-valued sequence is generated by the communication device 200. Alternatively, this random-valued sequence constitutes 5 bytes out of the eUICC challenge. In step S309 the SUCI is decrypted and verified. Then as part of step S309 an extra EAP round is performed as follows:
S309a: The random-valued sequence and device ephemeral public key is transferred to AUSF, where a MAC is calculated on the device ephemeral public key and where the random-valued sequence is used as the key when computing the MAC. SNN may also be transferred.
S309b: An EAP-Request is sent from AUSF back to the serving network as a response to step S307. The EAP-Request contains the MAC from step S309a. This may be the generic EAP-Request/Identity or a method-specific EAP-Request.
S309c: The EAP-Request is forwarded to the communication device 200, where the MAC is verified using the random-valued sequence stored at the communication device 200.
S309d: Upon successful verification of the MAC, the communication device 200 encrypts the eUICC challenge (excluding 5 bytes if already sent as the random-valued sequence), EID, and eUICCInfo1 (if not already available to the eSIM server 300) using the same way as when SUCI was encrypted. The communication device 200 also computes a MAC as is done for the SUCI.

S309e: In response to the authentication request received in step S309c, the communication device 200 returns an EAP-Response message containing the encrypted data and MAC computed in step S309d. Alternatively, a fully formatted SUCI can be sent containing the encrypted data, MAC, MCC+MNC, routing identifier, home public key identifier, protection scheme, and ephemeral public key of the communication device 200.

S309f: The serving network includes the EAP-Response message in an authentication request to the AUSF of the eSIM server 300.

S309g: The AUSF forwards the encrypted data and MAC (or full SUCI) to the UDM of the eSIM server 300 that process the encrypted data and the MAC in the same way as for SUCI, i.e. using same encryption key and MAC derived for SUCI the MAC is verified and encrypted data is decrypted to obtain eUICC challenge (possibly only remaining 11 bytes if random includes the other 5 bytes), EID, and optionally eUICCInfo1. Alternatively, if a fully formatted SUCI is received by the UDM the UDM discards any information obtained from the previous SUCI and processes the received SUCI from scratch.

From step S310 and onwards the method follows FIG. 5 and FIG. 6.

An alternative to the method in FIG. 7 is to use a proprietary protection scheme (if accepted by the serving network), where eUICC challenge, EID, and eUICCInfo1 all are included in encrypted form, claiming the longer length due to the proprietary protection scheme. In case of NSI-based SUPI there are no restrictions on the length of the username in the NAI format that is the part being encrypted. This means that it is possible to include EID (32 characters), eUICC challenge (32 characters) and possibly also eUICCInfo1 even when using a non-proprietary protection scheme.

In some variant to FIG. 7, an anonymized SUCI is created in step 304 that neither includes encrypted data, nor any device identifier, nor a public key of an ephemeral key pair of the communication device 200. Such a SUCI may be according to the SUCI null encryption format but where the MSIN part of the IMSI or user field of the user@realm is anonymized. For example, the MSIN part of the IMSI may contain only zeros. The encrypted eUICC challenge, device identifier, and the public key of the ephemeral key pair of the communication device 200 is instead obtained in the extra EAP round in step 309. For example, the data is obtained as a fully formatted SUCI. In this case, when the eSIM server (200) detects an anonymized SUCI, as part of step S309 an extra EAP round is performed as follows:
S309a: The UDM request the AUSF to obtain the SUCI.
S309b: An EAP-Request is sent from AUSF back to the serving network as a response to step S307. The EAP-Request contains the MAC from step S309a. This may be the generic EAP-Request/Identity or a method-specific EAP-Request.
S309c: The EAP-Request is forwarded to the communication device 200.
S309d: The communication device 200 retrieves the device identifier (e.g. EID) and eUICC challenge (and possibly also the eUICCInfo1) from the eUICC. The communication device 200 calculates the SUCI following standard 5G SUCI generation where an ephemeral EC key pair is generated at the communication device 200 and used in the SUCI generation. The MCC+MNC or NSI realm/domain name is included in the SUCI, but where the concealed part of SUCI is the concatenation of the device identifier (e.g. EID) and the 16-byte eUICC challenge (and possibly eUICCInfo1).
S309e: In response to the authentication request received in step S309c, the communication device 200 returns an EAP-Response message containing SUCI generated in step S309d.
S309f: The serving network includes the EAP-Response message in an authentication request to the AUSF of the eSIM server 300.
S309g: The AUSF forwards the SUCI to the UDM of the eSIM server 300 that processes the SUCI as in step S309 of FIG. 5.

In some variants, neither the EID nor any other device identifier is transferred to the eSIM server 300 as part of the SUCI, nor as part of the encrypted data in the extra EAP round as shown in Error! Reference source not found. 7. The EID is part of the eUICC certificate that is part of the AuthenticateServerResponse transferred in step S321 to the eSIM server 300 and the validation that the communication device 200 uses the eSIM server 300 can be performed as part of step S322 instead of step S310. In step S311 the EID may be used in a localization decision and determining the subscription manager 400 to be used in step S313 and onwards, which requires the EID to be sent as part of the SUCI, or as part of the encrypted data in the extra EAP round.

As described above, a profile may be prepared for download where a Matching ID is used for identifying the profile at the subscription manager 400 during the profile download preparation. But the profile is not yet bound to a particular communication device 200 or eUICC with a particular EID. In this case the Matching Id needs to be provided to the communication device 200 before step S318 such that it can be included in the AuthenticateServerRequest. The end-user may have obtained an Activation Code (AC) containing the Matching ID when ordering a subscription from MNO2. For example, the AC may be obtained in the form of a QR code that is scanned by the communication device 200 to obtain the Matching ID e.g. between step S301 and S302. Alternatively, for communication devices 200 without UI that are remotely managed, and where the eSIM service is used together with the eSIM server 300, the Matching Id may be provided as part of the encrypted data in steps S316 to S318.

If an Activation Code is used, also other pieces of data such as the eSIM server long term EC public key, the address of the eSIM server 300, the SUPI information of the eSIM server 300, SUCI routing information and the SUCI home public key identifier may be obtained through the Activation Code instead of being pre-configured in step S300.

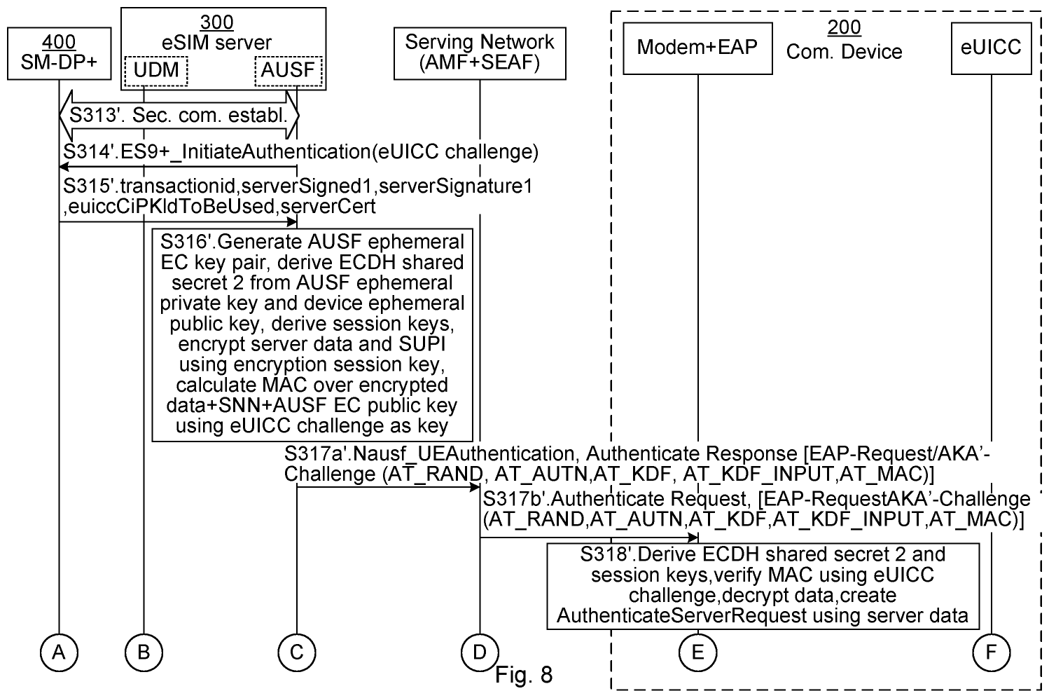

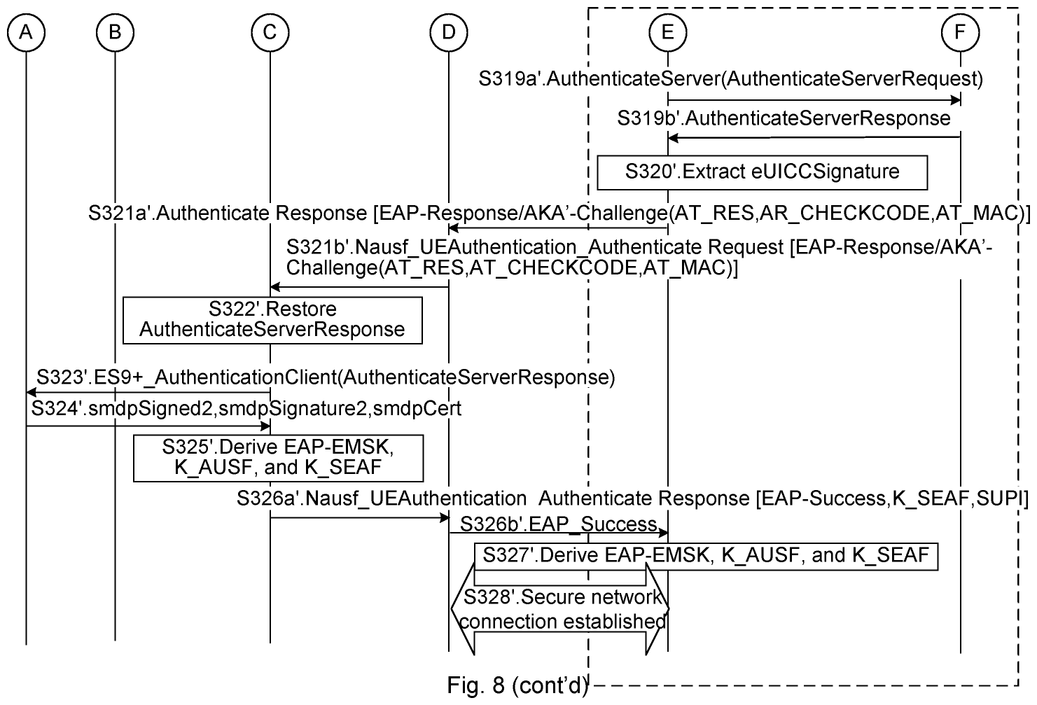

An embodiment for 5G network access authentication using EAP-AKA′ and eSIM credentials based on at least some of the above disclosed embodiments will now be disclosed in detail with reference to the signalling diagram of FIG. 8.

The method in FIG. 8 represents an optimized data exchange between the eSIM server 300 and the communication device 200 to allow EAP-AKA′ formatted messages to be used. By fitting the method into an EAP-AKA′ exchange the method will be accepted by the serving network as a primary authentication network access authentication method for use with public networks.

In order to fit the above exchange using EAP-AKA′ messages the following data might be pre-configured in the database of the eSIM server 300 for each device using the service: eUICC certificate, EUM certificate, eUICCInfo2 (and eUICCInfo1 as eUICCInfo1 is a subset of eUICCInfo2), and DeviceInfo fields, and deviceCapabilities, possibly also the full IMEI.

Besides this change in step S300 of FIG. 5, the remaining steps of FIG. 5 remain the same when using EAP-AKA′. The other differences are in FIG. 6. The EAP message exchange when EAP-AKA′ is used is illustrated in FIG. 8.

Steps S313′, to S316′ of FIG. 8 are identical to steps S133 to S316 of FIG. 6. In order to save space, the eUICC challenge of serverSigned1 is removed reducing the size with 16 bytes.
S317: The AUSF ephemeral public key, SNN, MAC, and the encrypted server data and SUPI are transferred in the EAP-Request/AKA′-Challenge sent from AUSF back to the serving network as a response to step S307 of FIG. 5 and is forwarded by the serving network to the communication device 200. The data is stored in the attributes of EAP-Request/AKA′-Challenge as follows: AT_RAND: First 16 bytes of AUSF ephemeral public key, AT_AUTN: Second 16 bytes of AUSF ephemeral public key, AT_KDF_INPUT: SNN, last 32 bytes of AUSF ephemeral public key, encrypted (server data +SUPI), AT_KDF: 2-byte reserved value indicating what KDF to be used, AT_MAC: MAC on encrypted data concatenated with AUSF ephemeral public key, e.g. HMAC-SHA256 truncated to 16 bytes.
S318′: Same as step S318 in FIG. 6 with the addition that serverSigned1 is restored by inserting the eUICC challenge. Whether the communication device 200 includes the full IMEI in DeviceInfo field of AuthenticateServerRequest is pre-configured.
S319′: Same as S319.
S320′: The modem parses the AuthenticateServerResponse and extracts the 64-byte eUICCSignature1 field.
S321′: In response to the authentication request received in step S317b′, the modem returns an EAP-Response/AKA′-Challenge containing the eUICC signature. The serving network includes the EAP-Response/AKA′-Challenge in an authentication request to the AUSF of the eSIM server 300. The 64-byte signature is stored in the attributes of EAP-Response/AKA′-Challenge as follows: AT_RES: First 16 bytes of eUICCSignature1, AT_CHECKCODE: Next 32 bytes of eUICCSignature1, AT_MAC: Last 16 bytes of eUICCSignature1.
S322′: The eSIM server 300 restores the AuthenticateServerResponse using data from serverSigned1, eUICCInfo2, DeviceInfo, eUICC certificate, and EUM certificate.

The remaining steps S323′ to S328′ are identical to steps S323 to S328.

The AT_KDF_INPUT attribute of step S317′ normally contains the SNN. It is here extended with the last 32 bytes of AUSF ephemeral public key and the encrypted server data and SUPI.

The AT_CHECKCODE attribute of step S321 can be sent according to the EAP-AKA′ specification. It is here used to transfer the complete signature. An alternative to this is to first signal a sequence number synchronization and transfer first part of the signature as a response (i.e. attributes AT_AUTS and AT_MAC are returned in the response) and then as a second AKA′-Challenge round transfer the rest of the signature.

Some of the data of eUICCInfo2 related to available memory for profile installation in the eUICC may change during the life-time of the communication device 200. Likely, no changes to the memory are done since the eUICCInfo2 is extracted from the communication device 200 during eUICC personalization. But if there are changes to the size, these new values need to be communicated for the eSIM server 300 to correctly restore AuthenticateServerResponse. One way to accomplish this is to signal a sequence number synchronization and transfer the values of the non-static parts that can change. Alternatively, the non-static parts may be included along with eUICC challenge and EID as part of the SUCI, or in the extra EAP round of FIG. 7.

The variants described above, except for not sending the EID/device identifier as part of SUCI, are applicable also when EAP-AKA′ formatted messages are used. EID is needed to be transferred before step S322′ such that the proper eUICCInfo2, DeviceInfo, eUICC certificate, and EUM certificate can be fetched from the database.

The method in FIG. 7 with an extra EAP round is valid also for EAP-AKA′. The extra round can either be an EAP-Request/Identity and EAP-Response/Identity pair of messages or an EAP-Request/AKA-Identity and EAP-Response/AKA-Identity pair of messages. In the first case the EAP-Response/Identity is required to be formatted as a SUCI. In the latter case the attribute AT_FULLAUTH_REQ is included in the request and the attribute AT_IDENTITY is included in the response, where the AT_IDENTITY is required to be formatted as a SUCI. Yet another SUCI means yet another 5 bytes of encrypted data can be transferred when a strict SUCI format is followed. However, since the device ephemeral public key was already sent when transferring the SUCI in steps S305′ to S308′, it does not need to be included again.

Instead, those 32 bytes of the SUCI can be used to transfer the remaining encrypted eUICC challenge bytes, the encrypted EID, and the encrypted non-static parts of the eUICCInfo2.

An embodiment for combined initial connectivity and profile download flow based on at least some of the above disclosed embodiments will now be disclosed in detail with reference to the signalling diagram of FIG. 9.

A method for combined initial connectivity and profile download where common mutual authentication between the subscription manager 400 and the eUICC is performed once and serves the purpose of both network access authentication for initial connectivity and mutual authentication for profile download, where the latter is disclosed next.
S401: The communication device 200 obtains initial connectivity via a serving network where network access authentication is performed as disclosed above, e.g. with reference to FIGS. 5 to 8 with described variants. As part of the network access authentication a profile download session is started with the subscription manager 400 where an HTTPS session is established between the subscription manager 400 and the eSIM server 300 and where common mutual authentication between the subscription manager 400 and the eUICC is performed. At the end of the network access authentication the eSIM server 300 and the communication device 200 have established a shared key for future secure communication exchanges. For example, such a shared key may be derived by both the eSIM server and the communication device from the ECDH shared secret 2.
S402: The communication device 200 obtains IP connectivity and establishes a secure communication with the eSIM server 300. The address of the eSIM server 300 is either pre-configured or obtained during the initial connectivity. The secure communication relies on the shared key established during the network access authentication e.g. using (Datagram) Transport Layer Security pre-shared key ciphersuites ((D)TLS-PSK).
S403: The communication device 200 requests to download the operational profile, i.e. continue the profile download session started as part of the network access authentication.
S404: The eSIM server 300 sends a request to the communication device 200 to prepare download, formatted as a PrepareDownloadRequest containing the smdpSigned2, smdpSignature2, and smdpCertificate obtained from the subscription manager 400 in step S324 or S324′.
S405: The modem (e.g. the Local Profile Assistant (LPA) component) forwards the PrepareDownloadRequest to the eUICC.
S406: Following the GSMA consumer eSIM standard, the eUICC verifies the request and, upon successful verification, prepares a PrepareDownloadResponse that is returned to the modem.
S407: The PrepareDownloadResponse is returned to the eSIM server 300.
S408: The eSIM server 300 sends an ES9+_GetBoundProfilePackage command to the subscription manager 400 to request the protected (operational) profile, also known as Bound Profile Package (BPP). A PrepareDownloadResponse (denoted PrepDLresp in the figure) is included in the command.
S409: Following the GSMA consumer eSIM standard, the subscription manager 400 verifies the PrepareDownloadResponse, and, upon successful verification, prepares the BPP that is returned to the eSIM server 300.
S410: The eSIM server 300 sends a request to the communication device 200 to install the protected profile (i.e. the BPP).
S411: The modem forwards the BPP to the eUICC.
S412: Following the GSMA consumer eSIM standard, the eUICC parses and verifies the BPP and, upon successful verification, installs the profile. The eUICC prepares a ProfileInstallationResult structure with the result of the profile installation that is returned to the modem.
S413: The ProfileInstallationResult is returned to the eSIM server 300.
S414: The eSIM server 300 sends an ES9+_HandleNotification command to the subscription manager 400 to notify the subscription manager 400 about the profile installation that may in turn notify the MNO owning the operational profile about the installation. The ProfileInstallationResult is included in the command.
S415: Upon receiving an acknowledgement on successful delivery of the notification from the subscription manager 400, the eSIM server 300 sends a request to the communication device 200 to delete the notification (i.e. ProfileInstallationResult) from its memory. The sequence number indicates what notification to be deleted.
S416: The modem requests the eUICC to delete the ProfileInstallationResult notification.
S417: Upon acknowledgement from the modem on successful deletion of the notification, the eSIM server 300 sends a request to the communication device 200 to enable the new operational profile. The ICCID of the profile to be enabled is included.
S418: The modem requests the eUICC to enable the profile. The eUICC enables the new profile and generates and stores an enable-profile notification.
S419: Upon acknowledgement from the modem on successful enabling of the profile, the eSIM server 300 sends a request to the device to retrieve the enable-profile notification.
S420: The modem requests the eUICC to retrieve the enable-profile notification.
S421: The notification is returned to the modem and further to the eSIM server 300.
S422: The eSIM server 300 sends an ES9+_HandleNotification command to the subscription manager 400 to notify the SM about the enabling of the profile that may in turn notify the MNO owning the operational profile about the enabling of the profile. The notification is included in the command.
S423: Upon receiving an acknowledgement on successful delivery of the notification from the subscription manager 400, the eSIM server 300 sends a request to the communication device 200 to delete the notification from its memory. The sequence number indicates what notification to be deleted.
S424: The modem requests the eUICC to delete the enable-profile notification. The eUICC deletes the notification and the modem acknowledge this to the eSIM server 300 that closes the connection with the SM.

Constrained communication devices 200 might be configured to communicate via a device management entity, also known as a Managing Entity. Hence, there might be a Managing Entity in the signalling path between the communication device 200 and the eSIM server 300 that handles protocol translation in case for example HTTPS communication is used between the eSIM server 300 and the Managing Entity and lightweight M2M (LwM2M) over Constrained Application Protocol (CoAP) over Datagram Transport Layer Security (DTLS) is used between the Managing Entity and the communication device 200. In this case existing secure communication might be leveraged between the communication device 200 and the Managing Entity and the shared key from step S401 is delivered from the communication device 200 to the Managing Entity for establishing secure communication with the eSIM server 300.

In some variants, the complete profile download is performed inside the EAP exchange as part of the network access authentication. In short, additional EAP request-response roundtrips need to be added to the method in FIG. 5 and FIG. 6 before the EAP-Success message is sent, and each such roundtrip would have to carry the ESiot messages of FIG. 9 and their responses.

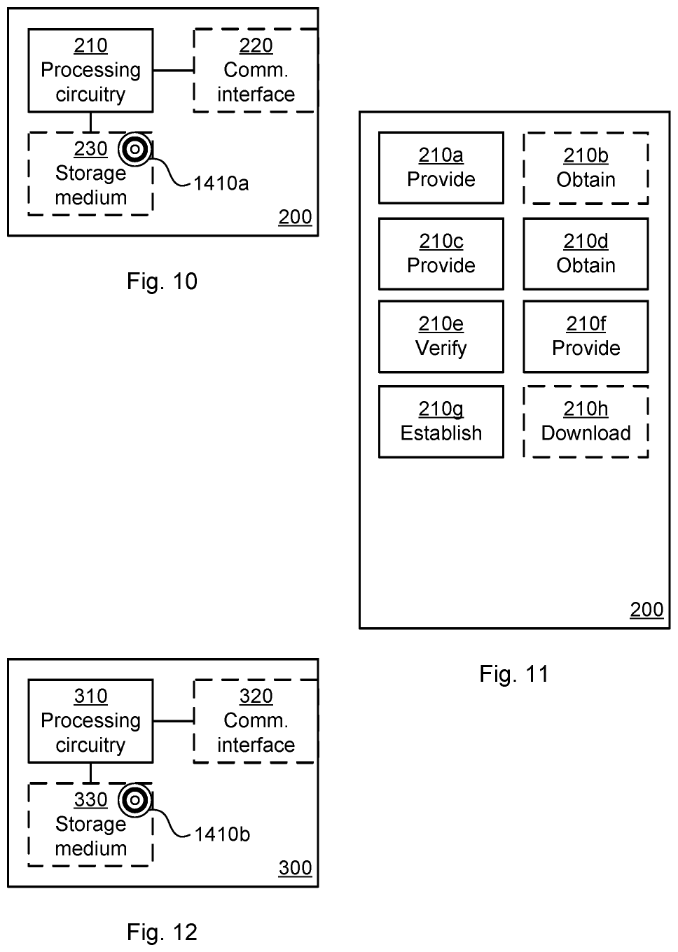

FIG. 10 schematically illustrates, in terms of a number of functional units, the components of a communication device 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1410a (as in FIG. 14), e.g. in the form of a storage medium 230. The processing circuitry 210 may further be provided as at least one application specific integrated circuit (ASIC), or field programmable gate array (FPGA).

Particularly, the processing circuitry 210 is configured to cause the communication device 200 to perform a set of operations, or steps, as disclosed above. For example, the storage medium 230 may store the set of operations, and the processing circuitry 210 may be configured to retrieve the set of operations from the storage medium 230 to cause the communication device 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The communication device 200 may further comprise a communications interface 220 for communications with other entities, functions, nodes, and devices, of the communication network of FIG. 2 as previously disclosed. As such the communications interface 220 may comprise one or more transmitters and receivers, comprising analogue and digital components.

The processing circuitry 210 controls the general operation of the communication device 200 e.g. by sending data and control signals to the communications interface 220 and the storage medium 230, by receiving data and reports from the communications interface 220, and by retrieving data and instructions from the storage medium 230. Other components, as well as the related functionality, of the communication device 200 are omitted in order not to obscure the concepts presented herein.

FIG. 11 schematically illustrates, in terms of a number of functional modules, the components of a communication device 200 according to an embodiment. The communication device 200 of FIG. 11 comprises a number of functional modules; a provide module 210a configured to perform step S102, a provide module 210c configured to perform step S106, an obtain module 210d configured to perform step S108, a verify module 210e configured to perform step S110, a provide module 210f configured to perform step S112, and an establish module 210g configured to perform step S114. The communication device 200 of FIG. 11 may further comprise a number of optional functional modules, such as any of an obtain module 210b configured to perform step S104, and a download module 210h configured to perform step S116.

In general terms, each functional module 210a:210h may be implemented in hardware or in software. Preferably, one or more or all functional modules 210a:210h may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210h and to execute these instructions, thereby performing any steps of the communication device 200 as disclosed herein.

FIG. 12 schematically illustrates, in terms of a number of functional units, the components of an eSIM server 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1410b (as in FIG. 14), e.g. in the form of a storage medium 330. The processing circuitry 310 may further be provided as at least one application specific integrated circuit (ASIC), or field programmable gate array (FPGA).

Particularly, the processing circuitry 310 is configured to cause the eSIM server 300 to perform a set of operations, or steps, as disclosed above. For example, the storage medium 330 may store the set of operations, and the processing circuitry 310 may be configured to retrieve the set of operations from the storage medium 330 to cause the eSIM server 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The eSIM server 300 may further comprise a communications interface 320 for communications with other entities, functions, nodes, and devices, of the communication network of FIG. 2. As such the communications interface 320 may comprise one or more transmitters and receivers, comprising analogue and digital components.

The processing circuitry 310 controls the general operation of the eSIM server 300 e.g. by sending data and control signals to the communications interface 320 and the storage medium 330, by receiving data and reports from the communications interface 320, and by retrieving data and instructions from the storage medium 330. Other components, as well as the related functionality, of the eSIM server 300 are omitted in order not to obscure the concepts presented herein.

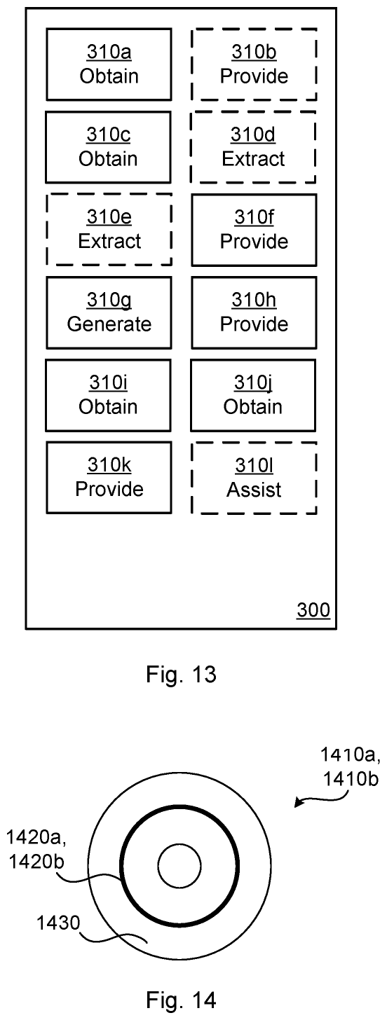

FIG. 13 schematically illustrates, in terms of a number of functional modules, the components of an eSIM server 300 according to an embodiment. The eSIM server 300 of FIG. 13 comprises a number of functional modules; an obtain module 310a configured to perform step S202, an obtain module 310c configured to perform step S206, a provide module 310f configured to perform step S208, a generate module 310g configured to perform step S210, a provide module 310h configured to perform step S212, an obtain module 310i configured to perform step S214, an obtain module 310j configured to perform step S216, and a provide module 310k configured to perform step S218. The eSIM server 300 of FIG. 13 may further comprise a number of optional functional modules, such as any of a provide module 310b configured to perform step S204, an extract module 310d configured to perform step S206a, an extract module 310fe configured to perform step S206b, and an assist module 310l configured to perform step S220.

In general terms, each functional module 310a:310l may be implemented in hardware or in software. Preferably, one or more or all functional modules 310a:310l may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310l and to execute these instructions, thereby performing any steps of the eSIM server 300 as disclosed herein.

The eSIM server 300 may be provided as a standalone device or as a part of at least one further device. For example, the eSIM server 300 may be provided in a node of the radio access network or in a node of the core network. Alternatively, functionality of the eSIM server 300 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the eSIM server 300 may be executed in a first device, and a second portion of the instructions performed by the eSIM server 300 may be executed in a second device; the herein disclosed embodiments are not limited to any particular number of devices on which the instructions performed by the eSIM server 300 may be executed. Hence, the methods according to the herein disclosed embodiments are suitable to be performed by a eSIM server 300 residing in a cloud computational environment. Therefore, although a single processing circuitry 310 is illustrated in FIG. 12 the processing circuitry 310 may be distributed among a plurality of devices, or nodes. The same applies to the functional modules 310a:310l of FIG. 13 and the computer program 1420b of FIG. 14.

FIG. 14 shows one example of a computer program product 1410a. 1410b comprising computer readable means 1430. On this computer readable means 1430, a computer program 1420a can be stored, which computer program 1420a can cause the processing circuitry 210 and thereto operatively coupled entities and devices, such as the communications interface 220 and the storage medium 230, to execute methods according to embodiments described herein. The computer program 1420a and/or computer program product 1410a may thus provide means for performing any steps of the communication device 200 as herein disclosed. On this computer readable means 1430, a computer program 1420b can be stored, which computer program 1420b can cause the processing circuitry 310 and thereto operatively coupled entities and devices, such as the communications interface 320 and the storage medium 330, to execute methods according to embodiments described herein. The computer program 1420b and/or computer program product 1410b may thus provide means for performing any steps of the eSIM server 300 as herein disclosed.

In the example of FIG. 14, the computer program product 1410a. 1410b is illustrated as an optical disc, such as a CD (compact disc) or a DVD (digital versatile disc) or a Blu-Ray disc. The computer program product 1410a, 1410b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1420a, 1420b is here schematically shown as a track on the depicted optical disk, the computer program 1420a, 1420b can be stored in any way which is suitable for the computer program product 1410a, 1410b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for establishing network connectivity for a communication device, the method being performed by the communication device, the communication device comprising an identity module supporting remote subscription profile download, the method comprising:
providing a SUCI, encrypted data comprising a device challenge, a public key of an ephemeral key pair of the communication device, and an identity module challenge towards an eSIM server, wherein the encrypted data is based on an eSIM server public key and the ephemeral key pair of the communication device;
obtaining a public key of an ephemeral key pair of the eSIM server, a subscription manager, SM, challenge, an SM signature, and authentication data from the eSIM server in an EAP request, wherein the SM challenge and the SM signature are extracted from the authentication data, and wherein the SM signature has been computed on data comprising the identity module challenge;
verifying the authentication data to obtain proof of the eSIM server knowledge of the device challenge, wherein the verification of the received authentication data is performed using the public key of the ephemeral key pair of the eSIM server and the device challenge, and wherein the SM signature is verified using the identity module and the identity module challenge as locally stored, and where an identity module signature computed on data comprising the received SM challenge is returned from the identity module upon successful verification;
providing an EAP response towards the eSIM server, the EAP response comprising the identity module signature; and
establishing network connectivity upon having obtained an EAP success message indicating successful authentication of the communication device.

2. The method according to claim 1, wherein the identity module challenge, the SM challenge, the SM signature, and the identity module signature follows a format used for handling remote subscription profile download to the identity module.

3. The method according to claim 1, wherein the SUCI comprises the encrypted data, a Message Authentication Code, MAC, over data comprising the device challenge, and the public key of the ephemeral key pair of the communication device, and wherein the MAC is based on an eSIM server public key and the ephemeral key pair of the communication device.

4. The method according to claim 1, wherein the device challenge provided in the encrypted data is the identity module challenge.

5. The method according to claim 1, wherein the encrypted data further is based on a device identifier of the communication device.

6-16. (canceled)

17. A method for assisting in establishing network connectivity for a communication device, the method being performed by an eSIM server, the method comprising:
obtaining a SUCI, encrypted data comprising a device challenge, a public key of an ephemeral key pair of the communication device, and an identity module challenge from the communication device, wherein the encrypted data is based on an eSIM server public key and the ephemeral key pair of the communication device;
providing the identity module challenge to a subscription manager over a secure communication channel established between the eSIM server and the subscription manager, and receiving a subscription manager, SM, challenge and an SM signature computed by the subscription manager on data comprising the identity module challenge in return from the subscription manager;
generating authentication data using an ephemeral key pair of the eSIM server, wherein the authentication data provides proof of the eSIM server knowledge of the device challenge, and wherein the authentication data comprises the SM challenge and the SM signature;
providing an EAP request towards the communication device, the EAP request comprising a public key of the ephemeral key pair of the eSIM server and the authentication data;
obtaining an EAP response from the communication device in an authentication request, wherein the EAP response comprising an identity module signature;
obtaining an indication of successful authentication of the communication device, wherein successful authentication of the communication device comprises successful verification of the identity module signature; and
providing, upon having obtained the indication of successful authentication of the communication device, a response to the authentication request towards the communication device comprising an EAP success message indicating successful authentication of the communication device for network connectivity to be established with the communication device.

18. The method according to claim 17, wherein the identity module challenge, the SM challenge, the SM signature, and the identity module signature, follows a format used for handling remote subscription profile download to the identity module.

19. The method according to claim 17, wherein the SUCI comprises the encrypted data, a Message Authentication Code, MAC, over data comprising the device challenge, and the public key of the ephemeral key pair of the communication device, and wherein the MAC is based on an eSIM server public key and the ephemeral key pair of the communication device.

20. The method according to claim 17, wherein the device challenge received from the communication device in the encrypted data is the identity module challenge.

21. The method according to claim 17, wherein the encrypted data further is based on a device identifier of the communication device.

22-31 (canceled)

32. A communication device for establishing network connection for the communication device, the communication device comprising an identity module supporting remote subscription profile download, the communication device comprising processing circuitry, the processing circuitry being configured to cause the communication device to:
provide a SUCI, encrypted data comprising a device challenge, a public key of an ephemeral key pair of the communication device, and an identity module challenge towards an eSIM server, wherein the encrypted data is based on an eSIM server public key and the ephemeral key pair of the communication device;
obtain a public key of an ephemeral key pair of the eSIM server, a subscription manager, SM, challenge, an SM signature, and authentication data from the eSIM server in an EAP request, wherein the SM challenge and the SM signature are extracted from the authentication data, and wherein the SM signature has been computed on data comprising the identity module challenge;
verify the authentication data to obtain proof of the eSIM server knowledge of the device challenge, wherein the verification of the received authentication data is performed using the public key of the ephemeral key pair of the eSIM server and the device challenge, and wherein the SM signature is verified using the identity module and the identity module challenge as locally stored, and where an identity module signature computed on data comprising the received SM challenge is returned from the identity module upon successful verification;
provide an EAP response towards the eSIM server, the EAP response comprising the identity module signature; and
establish network connectivity upon having obtained an EAP success message indicating successful authentication of the communication device.

33. A communication device for establishing network connection for the communication device, the communication device comprising an identity module supporting remote subscription profile download, the communication device comprising:
a provide module configured to provide a SUCI, encrypted data comprising a device challenge, a public key of an ephemeral key pair of the communication device, and an identity module challenge towards an eSIM server, wherein the encrypted data is based on an eSIM server public key and the ephemeral key pair of the communication device;
an obtain module configured to obtain a public key of an ephemeral key pair of the eSIM server, a subscription manager, SM, challenge, an SM signature, and authentication data from the eSIM server in an EAP request, wherein the SM challenge and the SM signature are extracted from the authentication data, and wherein the SM signature has been computed on data comprising the identity module challenge;
a verify module configured to verify the authentication data to obtain proof of the eSIM server knowledge of the device challenge, wherein the verification of the received authentication data is performed using the public key of the ephemeral key pair of the eSIM server and the device challenge, and wherein the SM signature is verified using the identity module and the identity module challenge as locally stored, and where an identity module signature computed on data comprising the received SM challenge is returned from the identity module upon successful verification;
a provide module configured to provide an EAP response towards the eSIM server, the EAP response comprising the identity module signature; and
an establish module configured to establish network connectivity upon having obtained an EAP success message indicating successful authentication of the communication device.

34-40 (canceled)

41. The communication device of claim 32, wherein the identity module challenge, the SM challenge, the SM signature, and the identity module signature follows a format used for handling remote subscription profile download to the identity module.

42. The communication device of claim 32, wherein the SUCI comprises the encrypted data, a Message Authentication Code, MAC, over data comprising the device challenge, and the public key of the ephemeral key pair of the communication device, and wherein the MAC is based on an eSIM server public key and the ephemeral key pair of the communication device.

43. The communication device of claim 32, wherein the device challenge provided in the encrypted data is the identity module challenge.

44. The communication device of claim 32, wherein the encrypted data further is based on a device identifier of the communication device.

45. The communication device of claim 33, wherein the identity module challenge, the SM challenge, the SM signature, and the identity module signature follows a format used for handling remote subscription profile download to the identity module.

46. The communication device of claim 3, wherein the SUCI comprises the encrypted data, a Message Authentication Code, MAC, over data comprising the device challenge, and the public key of the ephemeral key pair of the communication device, and wherein the MAC is based on an eSIM server public key and the ephemeral key pair of the communication device.

47. The communication device of claim 33, wherein the device challenge provided in the encrypted data is the identity module challenge.

48. The communication device of claim 33, wherein the encrypted data further is based on a device identifier of the communication device.
